(19) United States
(12) Patent Application Publication
(10) Pub. No.: US 2022/0311979 A1
(43) Pub. Date: Sep. 29, 2022

(54) WEARABLE APPARATUS FOR PROJECTING INFORMATION

(71) Applicant: OrCam Technologies Ltd., Jerusalem (IL)

(72) Inventors: Yonatan WEXLER, Jerusalem (IL); Amnon Shashua, Mevaseret Zion (IL)

(73) Assignee: Orcam Technologies Ltd., Jerusalem (IL)

(21) Appl. No.: 17/215,442

(22) Filed: Mar. 29, 2021

(51) Int. Cl. H04N 9/31; G06K 9/00; H04R 1/08; G10L 25/51; G06K 9/32; G03B 21/28; G06Q 30/06

(52) U.S. Cl. CPC H04N 9/3173; G06K 9/00664; H04N 9/3161; H04R 1/08; G10L 25/51; G06K 9/00604; G06K 9/00228; G06K 9/00288; G06K 9/3258; G03B 21/28; G06Q 30/0627

(57) ABSTRACT

Systems and methods are disclosed for using a wearable apparatus with overhead projection. In one implementation, a wearable apparatus may include an image sensor configured to capture a plurality of images from an environment of a user; a light projector; and at least one processor. The processor may be programmed to receive at least one image of the plurality of images; identify an item of information based on the at least one image; select a surface located within a field of view of the user; render the item of information into an informational image; and cause the projector to project the informational image onto the surface.

### BACKGROUND

### Technical Field

This disclosure generally relates to devices and methods for capturing and processing images and audio from an environment of a user, and using information derived from captured images and audio.

### Background Information

Today, technological advancements make it possible for wearable devices to automatically capture images and audio, and store information that is associated with the captured images and audio. Certain devices have been used to digitally record aspects and personal experiences of one's life in an exercise typically called “lifelogging.” Some individuals log their life so they can retrieve moments from past activities, for example, social events, trips, etc. Lifelogging may also have significant benefits in other fields (e.g., business, fitness and healthcare, and social research). Lifelogging devices, while useful for tracking daily activities, may be improved with capability to enhance one's interaction in his environment with feedback and other advanced functionality based on the analysis of captured image and audio data.

Even though users can capture images and audio with their smartphones and some smartphone applications can process the captured information, smartphones may not be the best platform for serving as lifelogging apparatuses in view of their size and design. Lifelogging apparatuses should be small and light, so they can be easily worn. Moreover, with improvements in image capture devices, including wearable apparatuses, additional functionality may be provided to assist users in navigating in and around an environment, identifying persons and objects they encounter, and providing feedback to the users about their surroundings and activities. Therefore, there is a need for apparatuses and methods for automatically capturing and processing images and audio to provide useful information to users of the apparatuses, and for systems and methods to process and leverage information gathered by the apparatuses.

### SUMMARY

Embodiments consistent with the present disclosure provide devices and methods for automatically capturing and processing images and audio from an environment of a user, and systems and methods for processing information related to images and audio captured from the environment of the user.

In an embodiment, a wearable apparatus may include an image sensor configured to capture a plurality of images from an environment of a user; a light projector; and at least one processor. The processor may be programmed to receive at least one image of the plurality of images; identify an item of information based on the at least one image; render the item of information into an informational image; select a surface located within a field of view of the user; and cause the projector to project the informational image onto the surface.

In an embodiment, a method of displaying information to a user may include: receiving at least one image captured by an image sensor from an environment of the user; receiving at least one audio signal representative of sounds captured by at least one microphone from the environment of the user; identifying an item of information based on at least one of the received at least one image or the received at least one audio signal; selecting a surface within a field of view of the user; rendering an informational image comprising the item of information; and projecting, using a projector, the informational image onto the surface.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a schematic illustration of an example of a user wearing a wearable apparatus according to a disclosed embodiment.

FIG. 1B is a schematic illustration of an example of the user wearing a wearable apparatus according to a disclosed embodiment.

FIG. 1C is a schematic illustration of an example of the user wearing a wearable apparatus according to a disclosed embodiment.

FIG. 1D is a schematic illustration of an example of the user wearing a wearable apparatus according to a disclosed embodiment.

FIG. 2 is a schematic illustration of an example system consistent with the disclosed embodiments.

FIG. 3A is a schematic illustration of an example of the wearable apparatus shown in FIG. 1A.

FIG. 3B is an exploded view of the example of the wearable apparatus shown in FIG. 3A.

FIG. 4A-4K are schematic illustrations of an example of the wearable apparatus shown in FIG. 1B from various viewpoints.

FIG. 5A is a block diagram illustrating an example of the components of a wearable apparatus according to a first embodiment.

FIG. 5B is a block diagram illustrating an example of the components of a wearable apparatus according to a second embodiment.

FIG. 5C is a block diagram illustrating an example of the components of a wearable apparatus according to a third embodiment.

FIG. 6 illustrates an exemplary embodiment of a memory containing software modules consistent with the present disclosure.

FIG. 7 is a schematic illustration of an embodiment of a wearable apparatus including an orientable image capture unit.

FIG. 8 is a schematic illustration of an embodiment of a wearable apparatus securable to an article of clothing consistent with the present disclosure.

FIG. 9 is a schematic illustration of a user wearing a wearable apparatus consistent with an embodiment of the present disclosure.

FIG. 10 is a schematic illustration of an embodiment of a wearable apparatus securable to an article of clothing consistent with the present disclosure.

FIG. 11 is a schematic illustration of an embodiment of a wearable apparatus securable to an article of clothing consistent with the present disclosure.

FIG. 12 is a schematic illustration of an embodiment of a wearable apparatus securable to an article of clothing consistent with the present disclosure.

FIG. 13 is a schematic illustration of an embodiment of a wearable apparatus securable to an article of clothing consistent with the present disclosure.

FIG. 14 is a schematic illustration of an embodiment of a wearable apparatus securable to an article of clothing consistent with the present disclosure.

FIG. 15 is a schematic illustration of an embodiment of a wearable apparatus power unit including a power source.

FIG. 16 is a schematic illustration of an exemplary embodiment of a wearable apparatus including protective circuitry.

FIG. 17A is a block diagram illustrating components of a wearable apparatus according to an example embodiment.

FIG. 17B is a block diagram illustrating the components of a wearable apparatus according to another example embodiment.

FIG. 17C is a block diagram illustrating the components of a wearable apparatus according to another example embodiment

FIG. 18 is another illustration of an example of the wearable apparatus shown in FIG. 1B.

FIG. 19 is a schematic illustration of a projection component consistent with the present disclosure.

FIG. 20 illustrates an exemplary embodiment of an apparatus comprising facial and voice recognition components consistent with the present disclosure.

FIG. 21 is a schematic illustration showing an exemplary environment for use of a projection system consistent with the present disclosure.

FIG. 22 is a flowchart showing an example process for displaying an item of information to the user consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

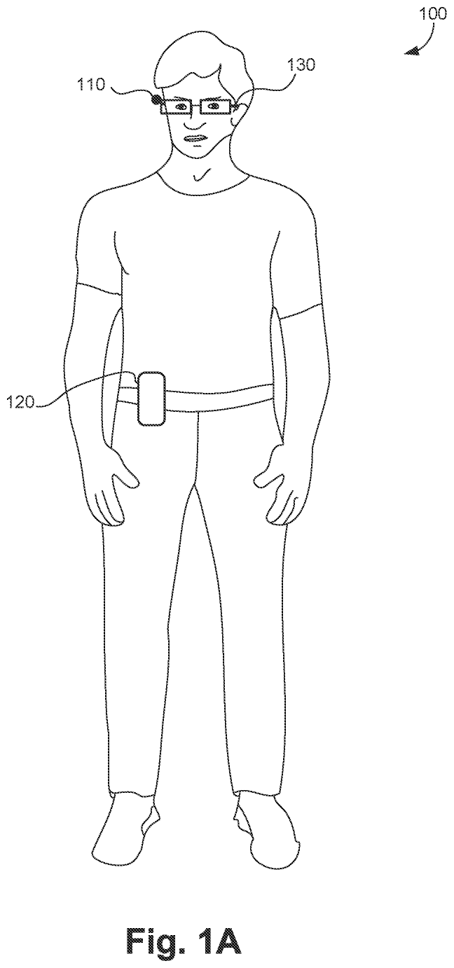

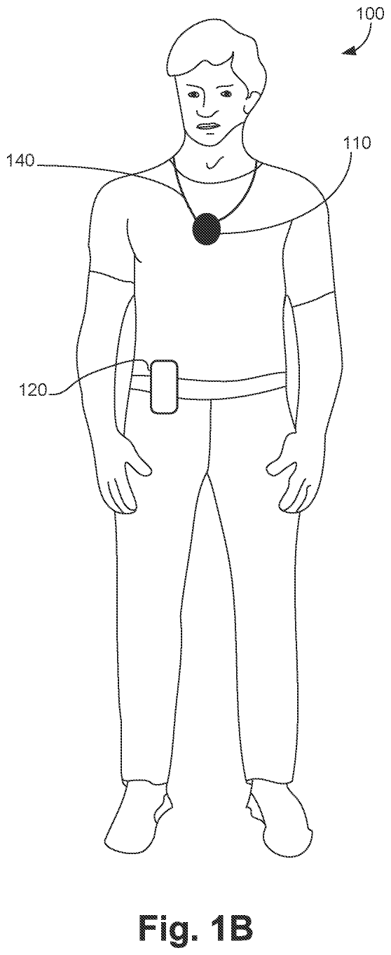

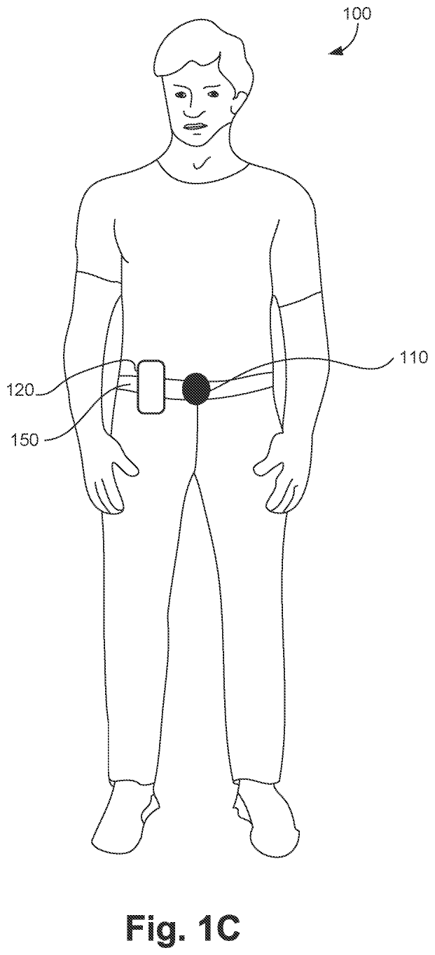

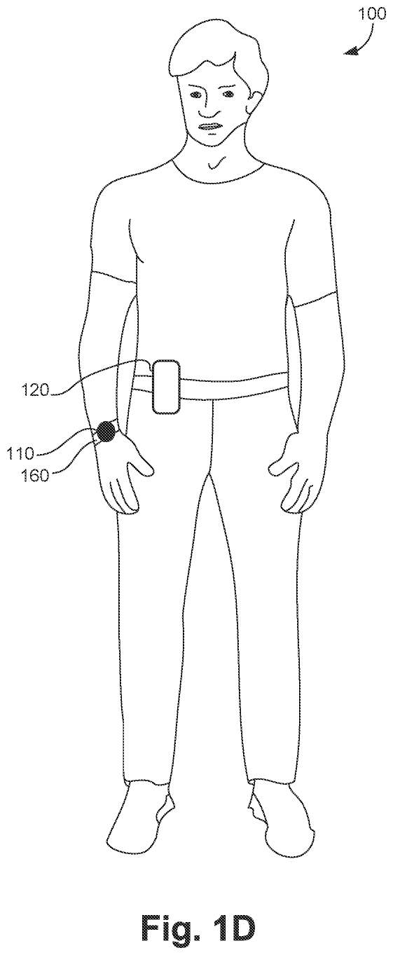

FIG. 1A illustrates a user 100 wearing an apparatus 110 that is physically connected (or integral) to glasses 130, consistent with the disclosed embodiments. Glasses 130 may be prescription glasses, magnifying glasses, non-prescription glasses, safety glasses, sunglasses, etc. Additionally, in some embodiments, glasses 130 may include parts of a frame and earpieces, nosepieces, etc., and one or no lenses. Thus, in some embodiments, glasses 130 may function primarily to support apparatus 110, and/or an augmented reality display device or other optical display device. In some embodiments, apparatus 110 may include an image sensor (not shown in FIG. 1A) for capturing real-time image data of the field-of-view of user 100. The term “image data” includes any form of data retrieved from optical signals in the near-infrared, infrared, visible, and ultraviolet spectrums. The image data may include video clips and/or photographs.

In some embodiments, apparatus 110 may communicate wirelessly or via a wire with a computing device 120. In some embodiments, computing device 120 may include, for example, a smartphone, or a tablet, or a dedicated processing unit, which may be portable (e.g., can be carried in a pocket of user 100). Although shown in FIG. 1A as an external device, in some embodiments, computing device 120 may be provided as part of wearable apparatus 110 or glasses 130, whether integral thereto or mounted thereon. In some embodiments, computing device 120 may be included in an augmented reality display device or optical head mounted display provided integrally or mounted to glasses 130. In other embodiments, computing device 120 may be provided as part of another wearable or portable apparatus of user 100 including a wrist-strap, a multifunctional watch, a button, a clip-on, etc. And in other embodiments, computing device 120 may be provided as part of another system, such as an on-board automobile computing or navigation system. A person skilled in the art can appreciate that different types of computing devices and arrangements of devices may implement the functionality of the disclosed embodiments. Accordingly, in other implementations, computing device 120 may include a Personal Computer (PC), laptop, an Internet server, etc.

FIG. 1B illustrates user 100 wearing apparatus 110 that is physically connected to a necklace 140, consistent with a disclosed embodiment. Such a configuration of apparatus 110 may be suitable for users that do not wear glasses some or all of the time. In this embodiment, user 100 can easily wear apparatus 110, and take it off.

FIG. 1C illustrates user 100 wearing apparatus 110 that is physically connected to a belt 150, consistent with a disclosed embodiment. Such a configuration of apparatus 110 may be designed as a belt buckle. Alternatively, apparatus 110 may include a clip for attaching to various clothing articles, such as belt 150, or a vest, a pocket, a collar, a cap or hat or other portion of a clothing article.

FIG. 1D illustrates user 100 wearing apparatus 110 that is physically connected to a wrist strap 160, consistent with a disclosed embodiment. Although the aiming direction of apparatus 110, according to this embodiment, may not match the field-of-view of user 100, apparatus 110 may include the ability to identify a hand-related trigger based on the tracked eye movement of a user 100 indicating that user 100 is looking in the direction of the wrist strap 160. Wrist strap 160 may also include an accelerometer, a gyroscope, or other sensor for determining movement or orientation of a user's 100 hand for identifying a hand-related trigger.

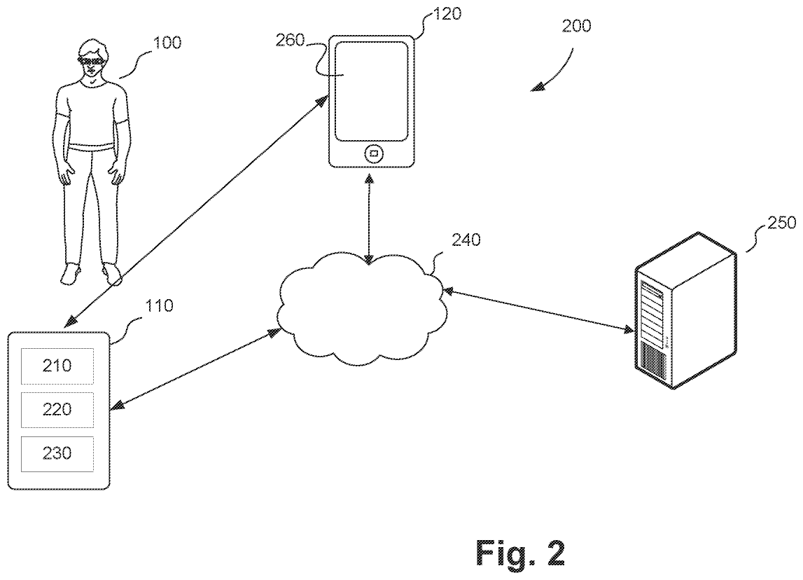

FIG. 2 is a schematic illustration of an exemplary system 200 including a wearable apparatus 110, worn by user 100, and an optional computing device 120 and/or a server 250 capable of communicating with apparatus 110 via a network 240, consistent with disclosed embodiments. In some embodiments, apparatus 110 may capture and analyze image data, identify a hand-related trigger present in the image data, and perform an action and/or provide feedback to a user 100, based at least in part on the identification of the hand-related trigger. In some embodiments, optional computing device 120 and/or server 250 may provide additional functionality to enhance interactions of user 100 with his or her environment, as described in greater detail below.

According to the disclosed embodiments, apparatus 110 may include an image sensor system 220 for capturing real-time image data of the field-of-view of user 100. In some embodiments, apparatus 110 may also include a processing unit 210 for controlling and performing the disclosed functionality of apparatus 110, such as to control the capture of image data, analyze the image data, and perform an action and/or output a feedback based on a hand-related trigger identified in the image data. According to the disclosed embodiments, a hand-related trigger may include a gesture performed by user 100 involving a portion of a hand of user 100. Further, consistent with some embodiments, a hand-related trigger may include a wrist-related trigger. Additionally, in some embodiments, apparatus 110 may include a feedback outputting unit 230 for producing an output of information to user 100.

As discussed above, apparatus 110 may include an image sensor 220 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 220 may be part of a camera included in apparatus 110.

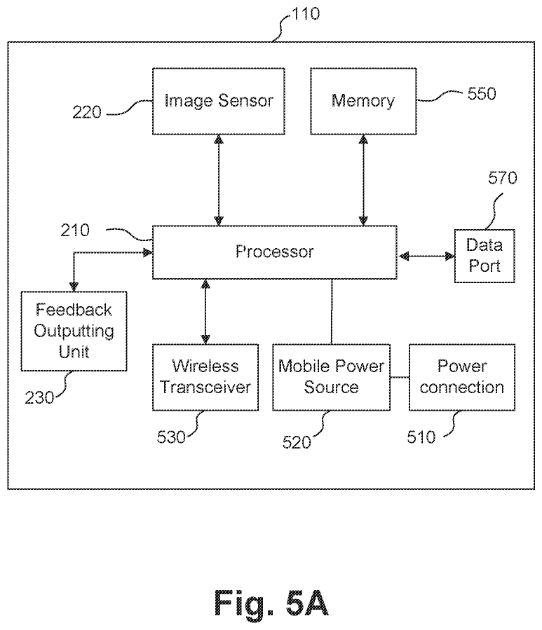

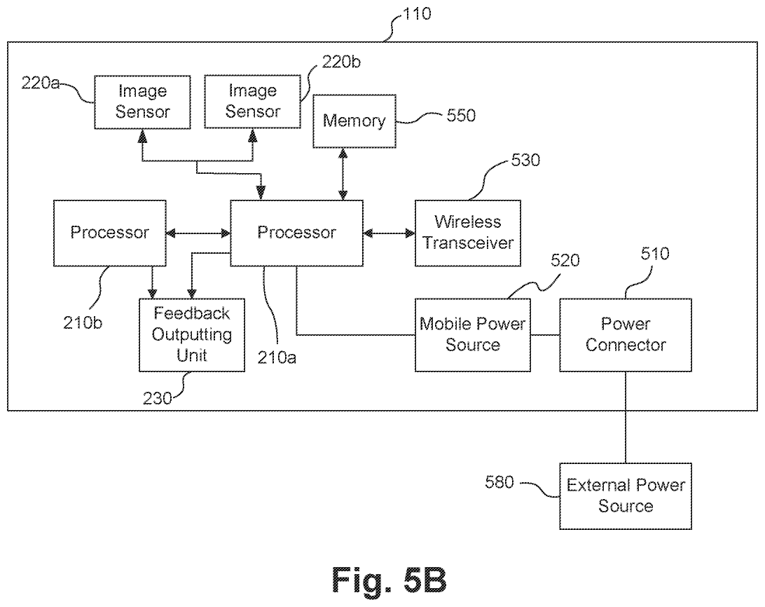

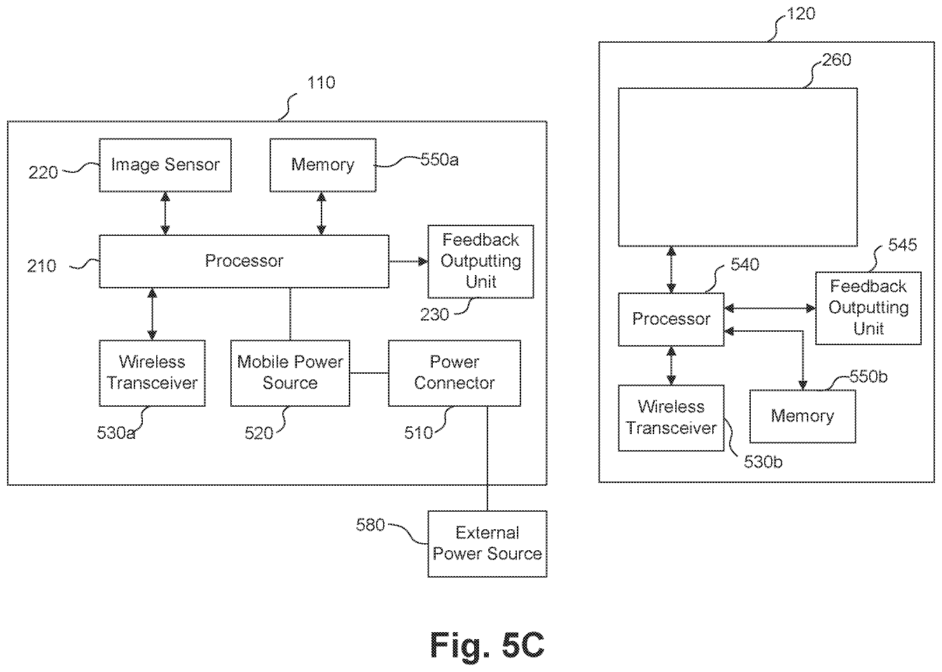

Apparatus 110 may also include a processor 210 for controlling image sensor 220 to capture image data and for analyzing the image data according to the disclosed embodiments. As discussed in further detail below with respect to FIG. 5A, processor 210 may include a “processing device” for performing logic operations on one or more inputs of image data and other data according to stored or accessible software instructions providing desired functionality. In some embodiments, processor 210 may also control feedback outputting unit 230 to provide feedback to user 100 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

In some embodiments, the information or feedback information provided to user 100 may include time information. The time information may include any information related to a current time of day and, as described further below, may be presented in any sensory perceptive manner. In some embodiments, time information may include a current time of day in a preconfigured format (e.g., 2:30 pm or 14:30). Time information may include the time in the user's current time zone (e.g., based on a determined location of user 100), as well as an indication of the time zone and/or a time of day in another desired location. In some embodiments, time information may include a number of hours or minutes relative to one or more predetermined times of day. For example, in some embodiments, time information may include an indication that three hours and fifteen minutes remain until a particular hour (e.g., until 6:00 pm), or some other predetermined time. Time information may also include a duration of time passed since the beginning of a particular activity, such as the start of a meeting or the start of a jog, or any other activity. In some embodiments, the activity may be determined based on analyzed image data. In other embodiments, time information may also include additional information related to a current time and one or more other routine, periodic, or scheduled events. For example, time information may include an indication of the number of minutes remaining until the next scheduled event, as may be determined from a calendar function or other information retrieved from computing device 120 or server 250, as discussed in further detail below.

Feedback outputting unit 230 may include one or more feedback systems for providing the output of information to user 100. In the disclosed embodiments, the audible or visual feedback may be provided via any type of connected audible or visual system or both. Feedback of information according to the disclosed embodiments may include audible feedback to user 100 (e.g., using a Bluetooth™ or other wired or wirelessly connected speaker, or a bone conduction headphone). Feedback outputting unit 230 of some embodiments may additionally or alternatively produce a visible output of information to user 100, for example, as part of an augmented reality display projected onto a lens of glasses 130 or provided via a separate heads up display in communication with apparatus 110, such as a display 260 provided as part of computing device 120, which may include an onboard automobile heads up display, an augmented reality device, a virtual reality device, a smartphone, PC, table, etc.

The term “computing device” refers to a device including a processing unit and having computing capabilities. Some examples of computing device 120 include a PC, laptop, tablet, or other computing systems such as an on-board computing system of an automobile, for example, each configured to communicate directly with apparatus 110 or server 250 over network 240. Another example of computing device 120 includes a smartphone having a display 260. In some embodiments, computing device 120 may be a computing system configured particularly for apparatus 110, and may be provided integral to apparatus 110 or tethered thereto. Apparatus 110 can also connect to computing device 120 over network 240 via any known wireless standard (e.g., Wi-Fi, Bluetooth®, etc.), as well as near-filed capacitive coupling, and other short range wireless techniques, or via a wired connection. In an embodiment in which computing device 120 is a smartphone, computing device 120 may have a dedicated application installed therein. For example, user 100 may view on display 260 data (e.g., images, video clips, extracted information, feedback information, etc.) that originate from or are triggered by apparatus 110. In addition, user 100 may select part of the data for storage in server 250.

Network 240 may be a shared, public, or private network, may encompass a wide area or local area, and may be implemented through any suitable combination of wired and/or wireless communication networks. Network 240 may further comprise an intranet or the Internet. In some embodiments, network 240 may include short range or near-field wireless communication systems for enabling communication between apparatus 110 and computing device 120 provided in close proximity to each other, such as on or near a user's person, for example. Apparatus 110 may establish a connection to network 240 autonomously, for example, using a wireless module (e.g., Wi-Fi, cellular). In some embodiments, apparatus 110 may use the wireless module when being connected to an external power source, to prolong battery life. Further, communication between apparatus 110 and server 250 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, apparatus 110 may transfer or receive data to/from server 250 via network 240. In the disclosed embodiments, the data being received from server 250 and/or computing device 120 may include numerous different types of information based on the analyzed image data, including information related to a commercial product, or a person's identity, an identified landmark, and any other information capable of being stored in or accessed by server 250. In some embodiments, data may be received and transferred via computing device 120. Server 250 and/or computing device 120 may retrieve information from different data sources (e.g., a user specific database or a user's social network account or other account, the Internet, and other managed or accessible databases) and provide information to apparatus 110 related to the analyzed image data and a recognized trigger according to the disclosed embodiments. In some embodiments, calendar-related information retrieved from the different data sources may be analyzed to provide certain time information or a time-based context for providing certain information based on the analyzed image data.

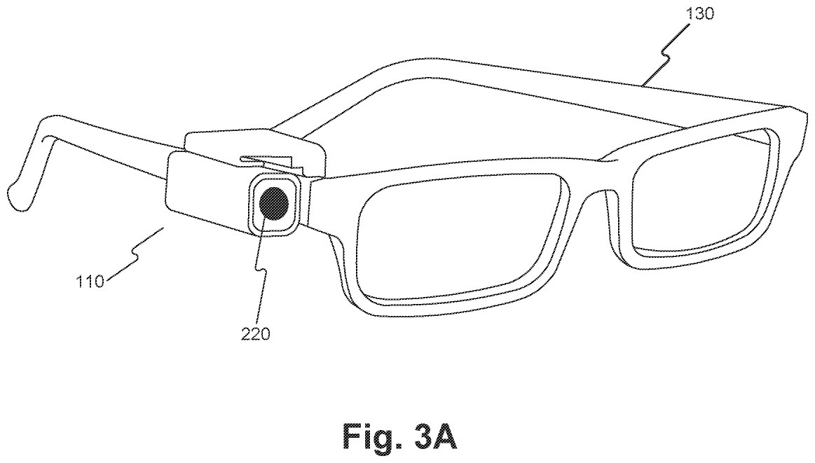

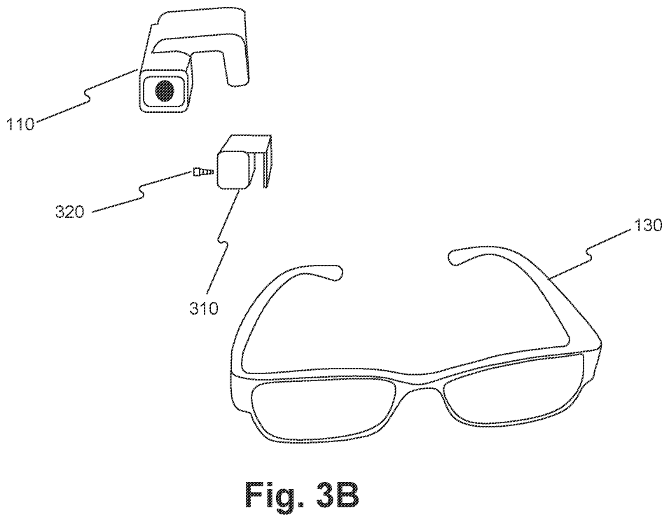

An example of wearable apparatus 110 incorporated with glasses 130 according to some embodiments (as discussed in connection with FIG. 1A) is shown in greater detail in FIG. 3A. In some embodiments, apparatus 110 may be associated with a structure (not shown in FIG. 3A) that enables easy detaching and reattaching of apparatus 110 to glasses 130. In some embodiments, when apparatus 110 attaches to glasses 130, image sensor 220 acquires a set aiming direction without the need for directional calibration. The set aiming direction of image sensor 220 may substantially coincide with the field-of-view of user 100. For example, a camera associated with image sensor 220 may be installed within apparatus 110 in a predetermined angle in a position facing slightly downwards (e.g., 5-15 degrees from the horizon). Accordingly, the set aiming direction of image sensor 220 may substantially match the field-of-view of user 100.

FIG. 3B is an exploded view of the components of the embodiment discussed regarding FIG. 3A. Attaching apparatus 110 to glasses 130 may take place in the following way. Initially, a support 310 may be mounted on glasses 130 using a screw 320, in the side of support 310. Then, apparatus 110 may be clipped on support 310 such that it is aligned with the field-of-view of user 100. The term “support” includes any device or structure that enables detaching and reattaching of a device including a camera to a pair of glasses or to another object (e.g., a helmet). Support 310 may be made from plastic (e.g., polycarbonate), metal (e.g., aluminum), or a combination of plastic and metal (e.g., carbon fiber graphite). Support 310 may be mounted on any kind of glasses (e.g., eyeglasses, sunglasses, 3D glasses, safety glasses, etc.) using screws, bolts, snaps, or any fastening means used in the art.

In some embodiments, support 310 may include a quick release mechanism for disengaging and reengaging apparatus 110. For example, support 310 and apparatus 110 may include magnetic elements. As an alternative example, support 310 may include a male latch member and apparatus 110 may include a female receptacle. In other embodiments, support 310 can be an integral part of a pair of glasses, or sold separately and installed by an optometrist. For example, support 310 may be configured for mounting on the arms of glasses 130 near the frame front, but before the hinge. Alternatively, support 310 may be configured for mounting on the bridge of glasses 130.

In some embodiments, apparatus 110 may be provided as part of a glasses frame 130, with or without lenses. Additionally, in some embodiments, apparatus 110 may be configured to provide an augmented reality display projected onto a lens of glasses 130 (if provided), or alternatively, may include a display for projecting time information, for example, according to the disclosed embodiments. Apparatus 110 may include the additional display or alternatively, may be in communication with a separately provided display system that may or may not be attached to glasses 130.

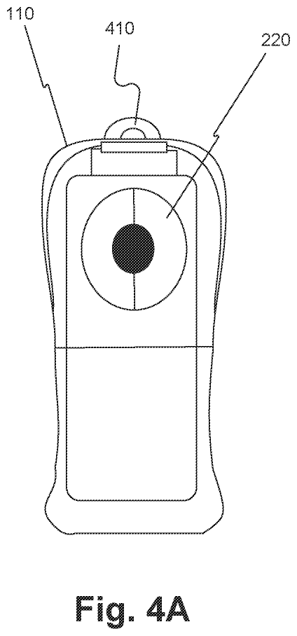

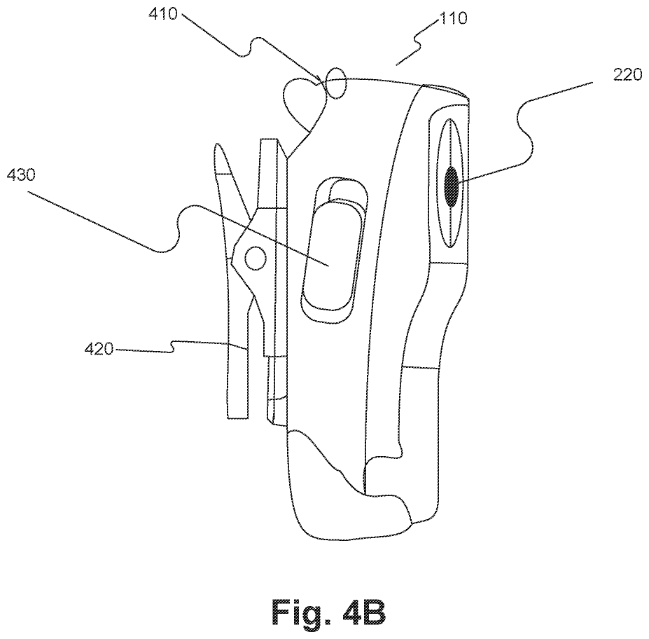

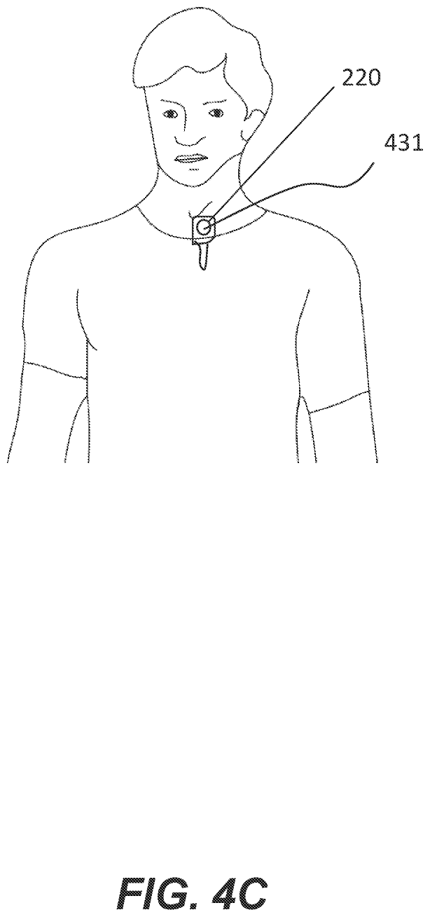

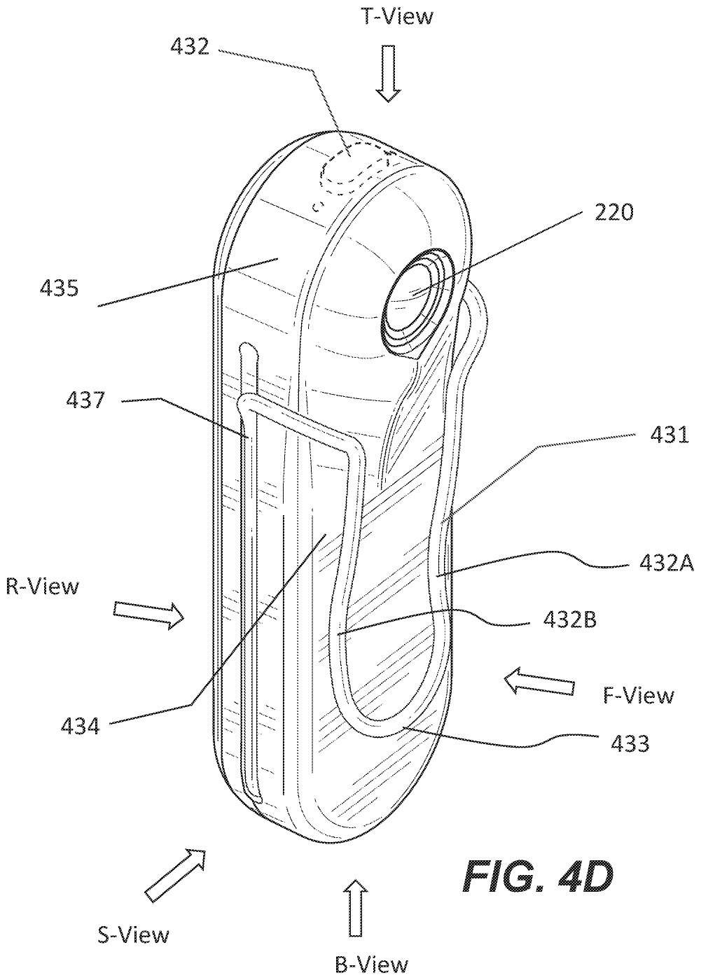

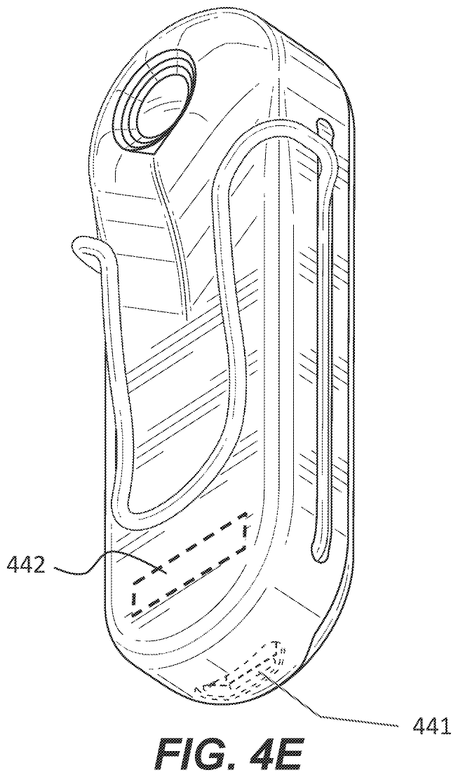

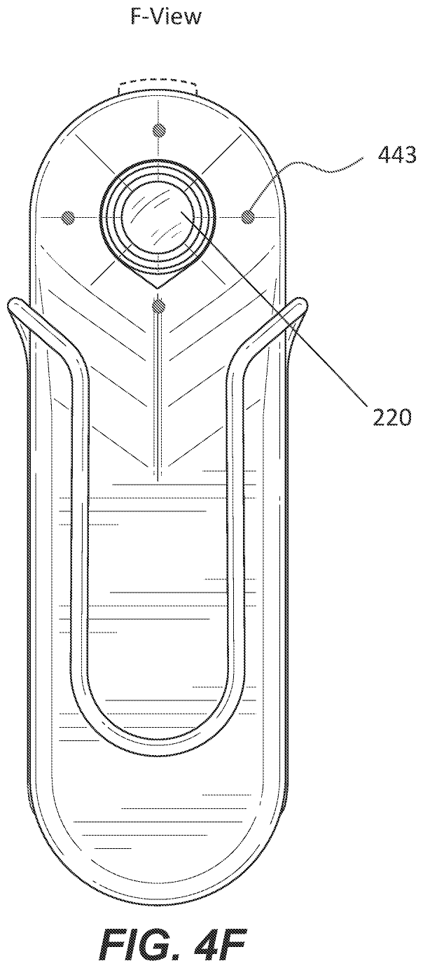

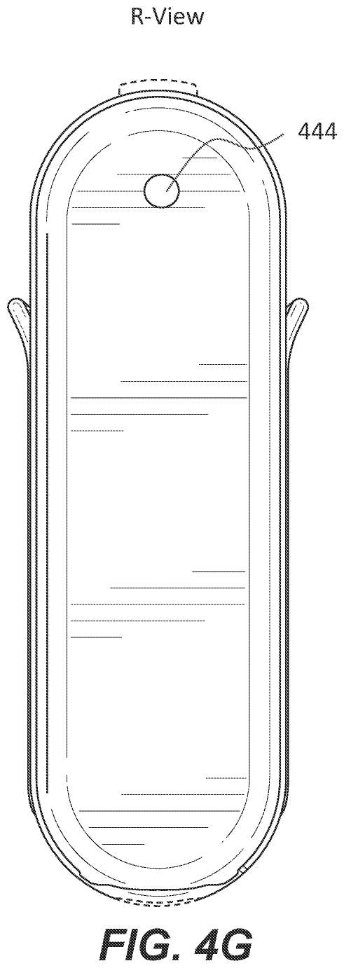

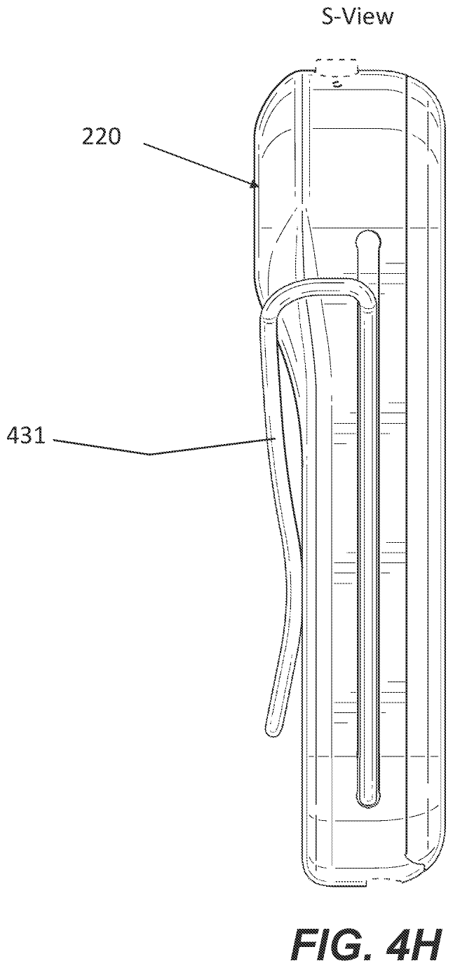

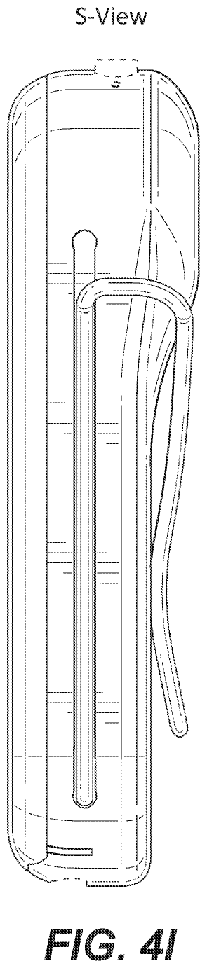

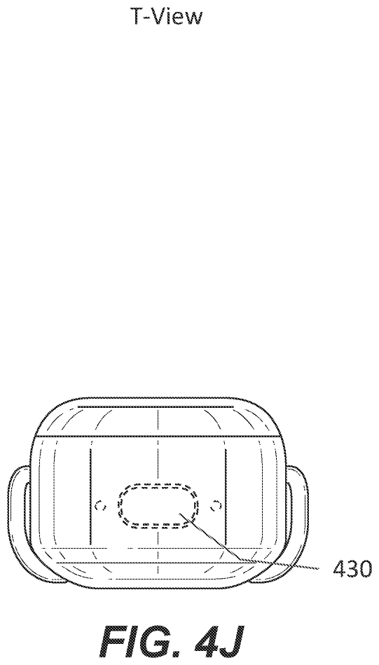

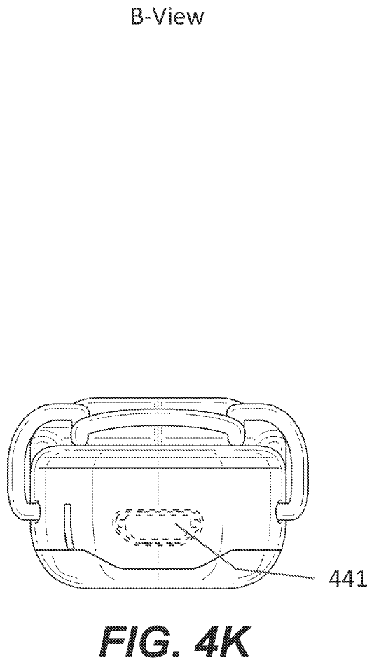

In some embodiments, apparatus 110 may be implemented in a form other than wearable glasses, as described above with respect to FIGS. 1B-1D, for example. FIG. 4A is a schematic illustration of an example of an additional embodiment of apparatus 110 from a front viewpoint of apparatus 110. Apparatus 110 includes an image sensor 220, a clip (not shown), a function button (not shown) and a hanging ring 410 for attaching apparatus 110 to, for example, necklace 140, as shown in FIG. 1B. When apparatus 110 hangs on necklace 140, the aiming direction of image sensor 220 may not fully coincide with the field-of-view of user 100, but the aiming direction would still correlate with the field-of-view of user 100.

FIG. 4B is a schematic illustration of the example of a second embodiment of apparatus 110, from a side orientation of apparatus 110. In addition to hanging ring 410, as shown in FIG. 4B, apparatus 110 may further include a clip 420. User 100 can use clip 420 to attach apparatus 110 to a shirt or belt 150, as illustrated in FIG. 1C. Clip 420 may provide an easy mechanism for disengaging and re-engaging apparatus 110 from different articles of clothing. In other embodiments, apparatus 110 may include a female receptacle for connecting with a male latch of a car mount or universal stand.

In some embodiments, apparatus 110 includes a function button 430 for enabling user 100 to provide input to apparatus 110. Function button 430 may accept different types of tactile input (e.g., a tap, a click, a double-click, a long press, a right-to-left slide, a left-to-right slide). In some embodiments, each type of input may be associated with a different action. For example, a tap may be associated with the function of taking a picture, while a right-to-left slide may be associated with the function of recording a video.

Apparatus 110 may be attached to an article of clothing (e.g., a shirt, a belt, pants, etc.), of user 100 at an edge of the clothing using a clip 431 as shown in FIG. 4C. For example, the body of apparatus 100 may reside adjacent to the inside surface of the clothing with clip 431 engaging with the outside surface of the clothing. In such an embodiment, as shown in FIG. 4C, the image sensor 220 (e.g., a camera for visible light) may be protruding beyond the edge of the clothing. Alternatively, clip 431 may be engaging with the inside surface of the clothing with the body of apparatus 110 being adjacent to the outside of the clothing. In various embodiments, the clothing may be positioned between clip 431 and the body of apparatus 110.

An example embodiment of apparatus 110 is shown in FIG. 4D. Apparatus 110 includes clip 431 which may include points (e.g., 432A and 432B) in close proximity to a front surface 434 of a body 435 of apparatus 110. In an example embodiment, the distance between points 432A, 432B and front surface 434 may be less than a typical thickness of a fabric of the clothing of user 100. For example, the distance between points 432A, 432B and surface 434 may be less than a thickness of a tee-shirt, e.g., less than a millimeter, less than 2 millimeters, less than 3 millimeters, etc., or, in some cases, points 432A, 432B of clip 431 may touch surface 434. In various embodiments, clip 431 may include a point 433 that does not touch surface 434, allowing the clothing to be inserted between clip 431 and surface 434.

FIG. 4D shows schematically different views of apparatus 110 defined as a front view (F-view), a rearview (R-view), a top view (T-view), a side view (S-view) and a bottom view (B-view). These views will be referred to when describing apparatus 110 in subsequent figures. FIG. 4D shows an example embodiment where clip 431 is positioned at the same side of apparatus 110 as sensor 220 (e.g., the front side of apparatus 110). Alternatively, clip 431 may be positioned at an opposite side of apparatus 110 as sensor 220 (e.g., the rear side of apparatus 110). In various embodiments, apparatus 110 may include function button 430, as shown in FIG. 4D.

Various views of apparatus 110 are illustrated in FIGS. 4E through 4K. For example, FIG. 4E shows a view of apparatus 110 with an electrical connection 441. Electrical connection 441 may be, for example, a USB port, that may be used to transfer data to/from apparatus 110 and provide electrical power to apparatus 110. In an example embodiment, connection 441 may be used to charge a battery 442 schematically shown in FIG. 4E. FIG. 4F shows F-view of apparatus 110, including sensor 220 and one or more microphones 443. In some embodiments, apparatus 110 may include several microphones 443 facing outwards, wherein microphones 443 are configured to obtain environmental sounds and sounds of various speakers communicating with user 100. FIG. 4G shows R-view of apparatus 110. In some embodiments, microphone 444 may be positioned at the rear side of apparatus 110, as shown in FIG. 4G. Microphone 444 may be used to detect an audio signal from user 100. It should be noted that apparatus 110 may have microphones placed at any side (e.g., a front side, a rear side, a left side, a right side, a top side, or a bottom side) of apparatus 110. In various embodiments, some microphones may be at a first side (e.g., microphones 443 may be at the front of apparatus 110) and other microphones may be at a second side (e.g., microphone 444 may be at the back side of apparatus 110).

FIGS. 4H and 4I show different sides of apparatus 110 (i.e., S-view of apparatus 110) consisted with disclosed embodiments. For example, FIG. 4H shows the location of sensor 220 and an example shape of clip 431. FIG. 4J shows T-view of apparatus 110, including function button 430, and FIG. 4K shows B-view of apparatus 110 with electrical connection 441.

The example embodiments discussed above with respect to FIGS. 3A, 3B, 4A, and 4B are not limiting. In some embodiments, apparatus 110 may be implemented in any suitable configuration for performing the disclosed methods. For example, referring back to FIG. 2, the disclosed embodiments may implement an apparatus 110 according to any configuration including an image sensor 220 and a processor unit 210 to perform image analysis and for communicating with a feedback unit 230.

FIG. 5A is a block diagram illustrating the components of apparatus 110 according to an example embodiment. As shown in FIG. 5A, and as similarly discussed above, apparatus 110 includes an image sensor 220, a memory 550, a processor 210, a feedback outputting unit 230, a wireless transceiver 530, and a mobile power source 520. In other embodiments, apparatus 110 may also include buttons, other sensors such as a microphone, and inertial measurements devices such as accelerometers, gyroscopes, magnetometers, temperature sensors, color sensors, light sensors, etc. Apparatus 110 may further include a data port 570 and a power connection 510 with suitable interfaces for connecting with an external power source or an external device (not shown).

Processor 210, depicted in FIG. 5A, may include any suitable processing device. The term “processing device” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by the processing device may, for example, be pre-loaded into a memory integrated with or embedded into the processing device or may be stored in a separate memory (e.g., memory 550). Memory 550 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although, in the embodiment illustrated in FIG. 5A, apparatus 110 includes one processing device (e.g., processor 210), apparatus 110 may include more than one processing device. Each processing device may have a similar construction, or the processing devices may be of differing constructions that are electrically connected or disconnected from each other. For example, the processing devices may be separate circuits or integrated in a single circuit. When more than one processing device is used, the processing devices may be configured to operate independently or collaboratively. The processing devices may be coupled electrically, magnetically, optically, acoustically, mechanically or by other means that permit them to interact.

In some embodiments, processor 210 may process a plurality of images captured from the environment of user 100 to determine different parameters related to capturing subsequent images. For example, processor 210 can determine, based on information derived from captured image data, a value for at least one of the following: an image resolution, a compression ratio, a cropping parameter, frame rate, a focus point, an exposure time, an aperture size, and a light sensitivity. The determined value may be used in capturing at least one subsequent image. Additionally, processor 210 can detect images including at least one hand-related trigger in the environment of the user and perform an action and/or provide an output of information to a user via feedback outputting unit 230.

In another embodiment, processor 210 can change the aiming direction of image sensor 220. For example, when apparatus 110 is attached with clip 420, the aiming direction of image sensor 220 may not coincide with the field-of-view of user 100. Processor 210 may recognize certain situations from the analyzed image data and adjust the aiming direction of image sensor 220 to capture relevant image data. For example, in one embodiment, processor 210 may detect an interaction with another individual and sense that the individual is not fully in view, because image sensor 220 is tilted down. Responsive thereto, processor 210 may adjust the aiming direction of image sensor 220 to capture image data of the individual. Other scenarios are also contemplated where processor 210 may recognize the need to adjust an aiming direction of image sensor 220.

In some embodiments, processor 210 may communicate data to feedback-outputting unit 230, which may include any device configured to provide information to a user 100. Feedback outputting unit 230 may be provided as part of apparatus 110 (as shown) or may be provided external to apparatus 110 and communicatively coupled thereto. Feedback-outputting unit 230 may be configured to output visual or nonvisual feedback based on signals received from processor 210, such as when processor 210 recognizes a hand-related trigger in the analyzed image data.

The term “feedback” refers to any output or information provided in response to processing at least one image in an environment. In some embodiments, as similarly described above, feedback may include an audible or visible indication of time information, detected text or numerals, the value of currency, a branded product, a person's identity, the identity of a landmark or other environmental situation or condition including the street names at an intersection or the color of a traffic light, etc., as well as other information associated with each of these. For example, in some embodiments, feedback may include additional information regarding the amount of currency still needed to complete a transaction, information regarding the identified person, historical information or times and prices of admission etc. of a detected landmark etc. In some embodiments, feedback may include an audible tone, a tactile response, and/or information previously recorded by user 100. Feedback-outputting unit 230 may comprise appropriate components for outputting acoustical and tactile feedback. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface. In some embodiments, feedback outputting unit 230 may also include any suitable display device for visually displaying information to user 100.

As shown in FIG. 5A, apparatus 110 includes memory 550. Memory 550 may include one or more sets of instructions accessible to processor 210 to perform the disclosed methods, including instructions for recognizing a hand-related trigger in the image data. In some embodiments memory 550 may store image data (e.g., images, videos) captured from the environment of user 100. In addition, memory 550 may store information specific to user 100, such as image representations of known individuals, favorite products, personal items, and calendar or appointment information, etc. In some embodiments, processor 210 may determine, for example, which type of image data to store based on available storage space in memory 550. In another embodiment, processor 210 may extract information from the image data stored in memory 550.

As further shown in FIG. 5A, apparatus 110 includes mobile power source 520. The term “mobile power source” includes any device capable of providing electrical power, which can be easily carried by hand (e.g., mobile power source 520 may weigh less than a pound). The mobility of the power source enables user 100 to use apparatus 110 in a variety of situations. In some embodiments, mobile power source 520 may include one or more batteries (e.g., nickel-cadmium batteries, nickel-metal hydride batteries, and lithium-ion batteries) or any other type of electrical power supply. In other embodiments, mobile power source 520 may be rechargeable and contained within a casing that holds apparatus 110. In yet other embodiments, mobile power source 520 may include one or more energy harvesting devices for converting ambient energy into electrical energy (e.g., portable solar power units, human vibration units, etc.).

Mobile power source 520 may power one or more wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data, processed image data, extracted information) from apparatus 110 to computing device 120 and/or server 250. Wireless transceiver 530 may also receive data from computing device 120 and/or server 250. In other embodiments, wireless transceiver 530 may transmit data and instructions to an external feedback outputting unit 230.

FIG. 5B is a block diagram illustrating the components of apparatus 110 according to another example embodiment. In some embodiments, apparatus 110 includes a first image sensor 220a, a second image sensor 220b, a memory 550, a first processor 210a, a second processor 210b, a feedback outputting unit 230, a wireless transceiver 530, a mobile power source 520, and a power connector 510. In the arrangement shown in FIG. 5B, each of the image sensors may provide images in a different image resolution, or face a different direction. Alternatively, each image sensor may be associated with a different camera (e.g., a wide angle camera, a narrow angle camera, an IR camera, etc.). In some embodiments, apparatus 110 can select which image sensor to use based on various factors. For example, processor 210a may determine, based on available storage space in memory 550, to capture subsequent images in a certain resolution.

Apparatus 110 may operate in a first processing-mode and in a second processing-mode, such that the first processing-mode may consume less power than the second processing-mode. For example, in the first processing-mode, apparatus 110 may capture images and process the captured images to make real-time decisions based on an identifying hand-related trigger, for example. In the second processing-mode, apparatus 110 may extract information from stored images in memory 550 and delete images from memory 550. In some embodiments, mobile power source 520 may provide more than fifteen hours of processing in the first processing-mode and about three hours of processing in the second processing-mode. Accordingly, different processing-modes may allow mobile power source 520 to produce sufficient power for powering apparatus 110 for various time periods (e.g., more than two hours, more than four hours, more than ten hours, etc.).

In some embodiments, apparatus 110 may use first processor 210a in the first processing-mode when powered by mobile power source 520, and second processor 210b in the second processing-mode when powered by external power source 580 that is connectable via power connector 510. In other embodiments, apparatus 110 may determine, based on predefined conditions, which processors or which processing modes to use. Apparatus 110 may operate in the second processing-mode even when apparatus 110 is not powered by external power source 580. For example, apparatus 110 may determine that it should operate in the second processing-mode when apparatus 110 is not powered by external power source 580, if the available storage space in memory 550 for storing new image data is lower than a predefined threshold.

Although one wireless transceiver is depicted in FIG. 5B, apparatus 110 may include more than one wireless transceiver (e.g., two wireless transceivers). In an arrangement with more than one wireless transceiver, each of the wireless transceivers may use a different standard to transmit and/or receive data. In some embodiments, a first wireless transceiver may communicate with server 250 or computing device 120 using a cellular standard (e.g., LTE or GSM), and a second wireless transceiver may communicate with server 250 or computing device 120 using a short-range standard (e.g., Wi-Fi or Bluetooth®). In some embodiments, apparatus 110 may use the first wireless transceiver when the wearable apparatus is powered by a mobile power source included in the wearable apparatus, and use the second wireless transceiver when the wearable apparatus is powered by an external power source.

FIG. 5C is a block diagram illustrating the components of apparatus 110 according to another example embodiment including computing device 120. In this embodiment, apparatus 110 includes an image sensor 220, a memory 550a, a first processor 210, a feedback-outputting unit 230, a wireless transceiver 530a, a mobile power source 520, and a power connector 510. As further shown in FIG. 5C, computing device 120 includes a processor 540, a feedback-outputting unit 545, a memory 550b, a wireless transceiver 530b, and a display 260. One example of computing device 120 is a smartphone or tablet having a dedicated application installed therein. In other embodiments, computing device 120 may include any configuration such as an on-board automobile computing system, a PC, a laptop, and any other system consistent with the disclosed embodiments. In this example, user 100 may view feedback output in response to identification of a hand-related trigger on display 260. Additionally, user 100 may view other data (e.g., images, video clips, object information, schedule information, extracted information, etc.) on display 260. In addition, user 100 may communicate with server 250 via computing device 120.

In some embodiments, processor 210 and processor 540 are configured to extract information from captured image data. The term “extracting information” includes any process by which information associated with objects, individuals, locations, events, etc., is identified in the captured image data by any means known to those of ordinary skill in the art. In some embodiments, apparatus 110 may use the extracted information to send feedback or other real-time indications to feedback outputting unit 230 or to computing device 120. In some embodiments, processor 210 may identify in the image data the individual standing in front of user 100, and send computing device 120 the name of the individual and the last time user 100 met the individual. In another embodiment, processor 210 may identify in the image data, one or more visible triggers, including a hand-related trigger, and determine whether the trigger is associated with a person other than the user of the wearable apparatus to selectively determine whether to perform an action associated with the trigger. One such action may be to provide a feedback to user 100 via feedback-outputting unit 230 provided as part of (or in communication with) apparatus 110 or via a feedback unit 545 provided as part of computing device 120. For example, feedback-outputting unit 545 may be in communication with display 260 to cause the display 260 to visibly output information. In some embodiments, processor 210 may identify in the image data a hand-related trigger and send computing device 120 an indication of the trigger. Processor 540 may then process the received trigger information and provide an output via feedback outputting unit 545 or display 260 based on the hand-related trigger. In other embodiments, processor 540 may determine a hand-related trigger and provide suitable feedback similar to the above, based on image data received from apparatus 110. In some embodiments, processor 540 may provide instructions or other information, such as environmental information to apparatus 110 based on an identified hand-related trigger.

In some embodiments, processor 210 may identify other environmental information in the analyzed images, such as an individual standing in front user 100, and send computing device 120 information related to the analyzed information such as the name of the individual and the last time user 100 met the individual. In a different embodiment, processor 540 may extract statistical information from captured image data and forward the statistical information to server 250. For example, certain information regarding the types of items a user purchases, or the frequency a user patronizes a particular merchant, etc. may be determined by processor 540. Based on this information, server 250 may send computing device 120 coupons and discounts associated with the user's preferences.

When apparatus 110 is connected or wirelessly connected to computing device 120, apparatus 110 may transmit at least part of the image data stored in memory 550a for storage in memory 550b. In some embodiments, after computing device 120 confirms that transferring the part of image data was successful, processor 540 may delete the part of the image data. The term “delete” means that the image is marked as ‘deleted’ and other image data may be stored instead of it, but does not necessarily mean that the image data was physically removed from the memory.

As will be appreciated by a person skilled in the art having the benefit of this disclosure, numerous variations and/or modifications may be made to the disclosed embodiments. Not all components are essential for the operation of apparatus 110. Any component may be located in any appropriate apparatus and the components may be rearranged into a variety of configurations while providing the functionality of the disclosed embodiments. For example, in some embodiments, apparatus 110 may include a camera, a processor, and a wireless transceiver for sending data to another device. Therefore, the foregoing configurations are examples and, regardless of the configurations discussed above, apparatus 110 can capture, store, and/or process images.

Further, the foregoing and following description refers to storing and/or processing images or image data. In the embodiments disclosed herein, the stored and/or processed images or image data may comprise a representation of one or more images captured by image sensor 220. As the term is used herein, a “representation” of an image (or image data) may include an entire image or a portion of an image. A representation of an image (or image data) may have the same resolution or a lower resolution as the image (or image data), and/or a representation of an image (or image data) may be altered in some respect (e.g., be compressed, have a lower resolution, have one or more colors that are altered, etc.).

For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that does not substantially include the environment surrounding the person. Similarly, apparatus 110 may, for example, store a portion of an image that includes a product that appears in the image, but does not substantially include the environment surrounding the product. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In addition to the above, in some embodiments, any one of apparatus 110 or computing device 120, via processor 210 or 540, may further process the captured image data to provide additional functionality to recognize objects and/or gestures and/or other information in the captured image data. In some embodiments, actions may be taken based on the identified objects, gestures, or other information. In some embodiments, processor 210 or 540 may identify in the image data, one or more visible triggers, including a hand-related trigger, and determine whether the trigger is associated with a person other than the user to determine whether to perform an action associated with the trigger.

Some embodiments of the present disclosure may include an apparatus securable to an article of clothing of a user. Such an apparatus may include two portions, connectable by a connector. A capturing unit may be designed to be worn on the outside of a user's clothing, and may include an image sensor for capturing images of a user's environment. The capturing unit may be connected to or connectable to a power unit, which may be configured to house a power source and a processing device. The capturing unit may be a small device including a camera or other device for capturing images. The capturing unit may be designed to be inconspicuous and unobtrusive, and may be configured to communicate with a power unit concealed by a user's clothing. The power unit may include bulkier aspects of the system, such as transceiver antennas, at least one battery, a processing device, etc. In some embodiments, communication between the capturing unit and the power unit may be provided by a data cable included in the connector, while in other embodiments, communication may be wirelessly achieved between the capturing unit and the power unit. Some embodiments may permit alteration of the orientation of an image sensor of the capture unit, for example to better capture images of interest.

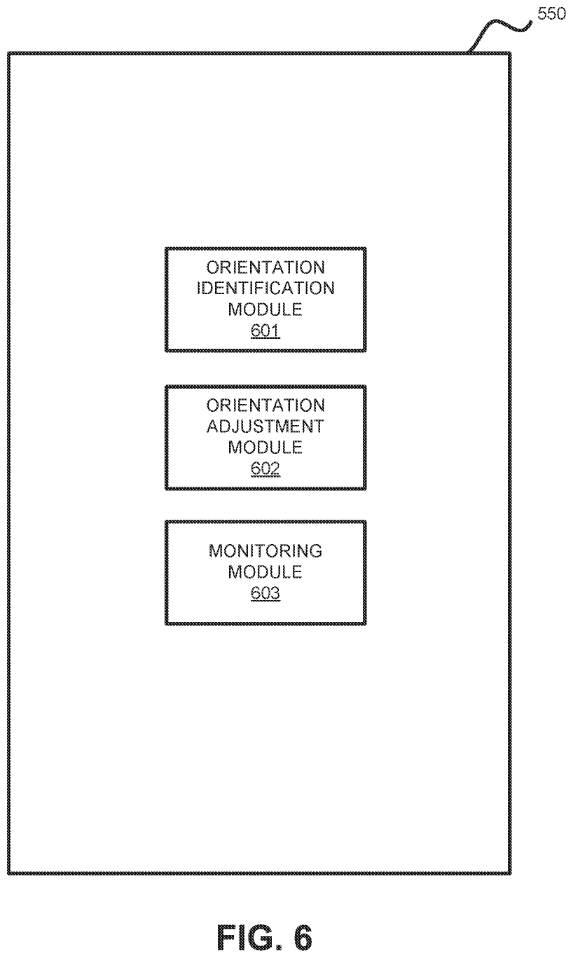

FIG. 6 illustrates an exemplary embodiment of a memory containing software modules consistent with the present disclosure. Included in memory 550 are orientation identification module 601, orientation adjustment module 602, and motion tracking module 603. Modules 601, 602, 603 may contain software instructions for execution by at least one processing device, e.g., processor 210, included with a wearable apparatus. Orientation identification module 601, orientation adjustment module 602, and motion tracking module 603 may cooperate to provide orientation adjustment for a capturing unit incorporated into wireless apparatus 110.

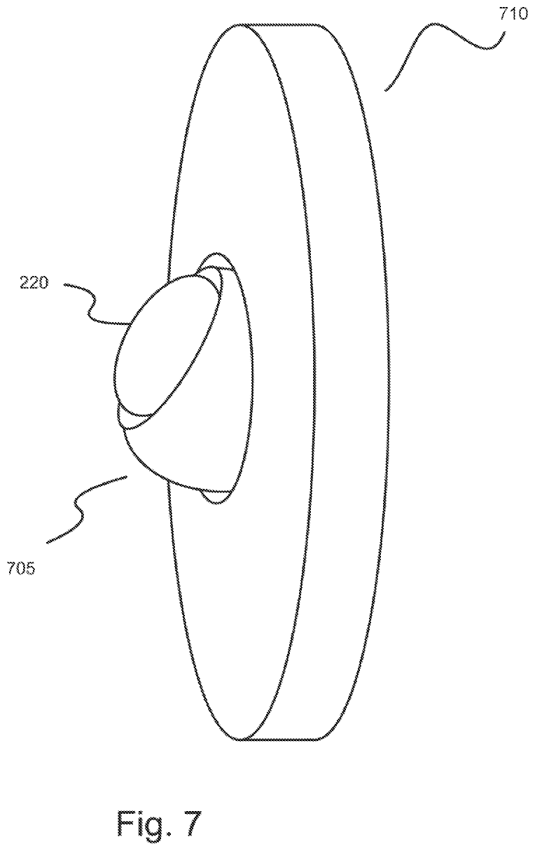

FIG. 7 illustrates an exemplary capturing unit 710 including an orientation adjustment unit 705. Orientation adjustment unit 705 may be configured to permit the adjustment of image sensor 220. As illustrated in FIG. 7, orientation adjustment unit 705 may include an eye-ball type adjustment mechanism. In alternative embodiments, orientation adjustment unit 705 may include gimbals, adjustable stalks, pivotable mounts, and any other suitable unit for adjusting an orientation of image sensor 220.

Image sensor 220 may be configured to be movable with the head of user 100 in such a manner that an aiming direction of image sensor 220 substantially coincides with a field of view of user 100. For example, as described above, a camera associated with image sensor 220 may be installed within capturing unit 710 at a predetermined angle in a position facing slightly upwards or downwards, depending on an intended location of capturing unit 710. Accordingly, the set aiming direction of image sensor 220 may match the field-of-view of user 100. In some embodiments, processor 210 may change the orientation of image sensor 220 using image data provided from image sensor 220. For example, processor 210 may recognize that a user is reading a book and determine that the aiming direction of image sensor 220 is offset from the text. That is, because the words in the beginning of each line of text are not fully in view, processor 210 may determine that image sensor 220 is tilted in the wrong direction. Responsive thereto, processor 210 may adjust the aiming direction of image sensor 220.

Orientation identification module 601 may be configured to identify an orientation of an image sensor 220 of capturing unit 710. An orientation of an image sensor 220 may be identified, for example, by analysis of images captured by image sensor 220 of capturing unit 710, by tilt or attitude sensing devices within capturing unit 710, and by measuring a relative direction of orientation adjustment unit 705 with respect to the remainder of capturing unit 710.

Orientation adjustment module 602 may be configured to adjust an orientation of image sensor 220 of capturing unit 710. As discussed above, image sensor 220 may be mounted on an orientation adjustment unit 705 configured for movement. Orientation adjustment unit 705 may be configured for rotational and/or lateral movement in response to commands from orientation adjustment module 602. In some embodiments orientation adjustment unit 705 may be adjust an orientation of image sensor 220 via motors, electromagnets, permanent magnets, and/or any suitable combination thereof.

In some embodiments, monitoring module 603 may be provided for continuous monitoring. Such continuous monitoring may include tracking a movement of at least a portion of an object included in one or more images captured by the image sensor. For example, in one embodiment, apparatus 110 may track an object as long as the object remains substantially within the field-of-view of image sensor 220. In additional embodiments, monitoring module 603 may engage orientation adjustment module 602 to instruct orientation adjustment unit 705 to continually orient image sensor 220 towards an object of interest. For example, in one embodiment, monitoring module 603 may cause image sensor 220 to adjust an orientation to ensure that a certain designated object, for example, the face of a particular person, remains within the field-of view of image sensor 220, even as that designated object moves about. In another embodiment, monitoring module 603 may continuously monitor an area of interest included in one or more images captured by the image sensor. For example, a user may be occupied by a certain task, for example, typing on a laptop, while image sensor 220 remains oriented in a particular direction and continuously monitors a portion of each image from a series of images to detect a trigger or other event. For example, image sensor 210 may be oriented towards a piece of laboratory equipment and monitoring module 603 may be configured to monitor a status light on the laboratory equipment for a change in status, while the user's attention is otherwise occupied.

In some embodiments consistent with the present disclosure, capturing unit 710 may include a plurality of image sensors 220. The plurality of image sensors 220 may each be configured to capture different image data. For example, when a plurality of image sensors 220 are provided, the image sensors 220 may capture images having different resolutions, may capture wider or narrower fields of view, and may have different levels of magnification. Image sensors 220 may be provided with varying lenses to permit these different configurations. In some embodiments, a plurality of image sensors 220 may include image sensors 220 having different orientations. Thus, each of the plurality of image sensors 220 may be pointed in a different direction to capture different images. The fields of view of image sensors 220 may be overlapping in some embodiments. The plurality of image sensors 220 may each be configured for orientation adjustment, for example, by being paired with an image adjustment unit 705. In some embodiments, monitoring module 603, or another module associated with memory 550, may be configured to individually adjust the orientations of the plurality of image sensors 220 as well as to turn each of the plurality of image sensors 220 on or off as may be required or preferred. In some embodiments, monitoring an object or person captured by an image sensor 220 may include tracking movement of the object across the fields of view of the plurality of image sensors 220.

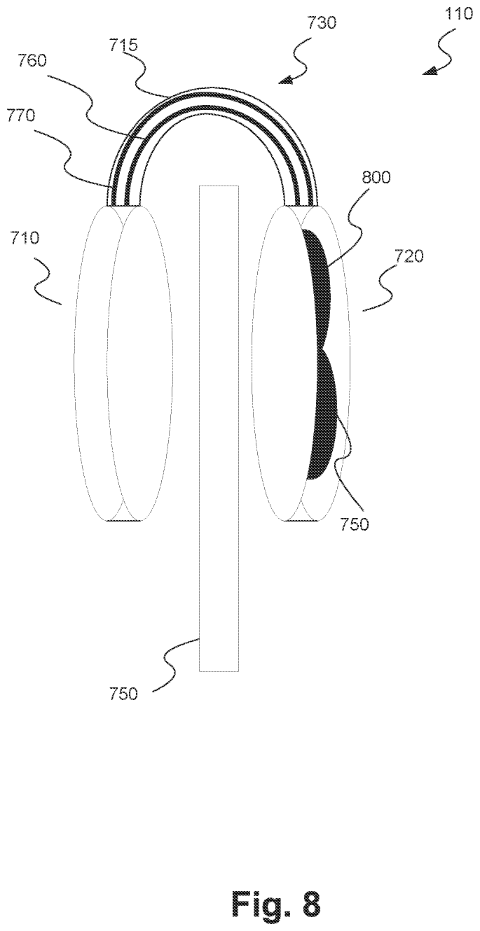

Embodiments consistent with the present disclosure may include connectors configured to connect a capturing unit and a power unit of a wearable apparatus. Capturing units consistent with the present disclosure may include least one image sensor configured to capture images of an environment of a user. Power units consistent with the present disclosure may be configured to house a power source and/or at least one processing device. Connectors consistent with the present disclosure may be configured to connect the capturing unit and the power unit, and may be configured to secure the apparatus to an article of clothing such that the capturing unit is positioned over an outer surface of the article of clothing and the power unit is positioned under an inner surface of the article of clothing. Exemplary embodiments of capturing units, connectors, and power units consistent with the disclosure are discussed in further detail with respect to FIGS. 8-14.

FIG. 8 is a schematic illustration of an embodiment of wearable apparatus 110 securable to an article of clothing consistent with the present disclosure. As illustrated in FIG. 8, capturing unit 710 and power unit 720 may be connected by a connector 730 such that capturing unit 710 is positioned on one side of an article of clothing 750 and power unit 720 is positioned on the opposite side of the clothing 750. In some embodiments, capturing unit 710 may be positioned over an outer surface of the article of clothing 750 and power unit 720 may be located under an inner surface of the article of clothing 750. The power unit 720 may be configured to be placed against the skin of a user.

Capturing unit 710 may include an image sensor 220 and an orientation adjustment unit 705 (as illustrated in FIG. 7). Power unit 720 may include mobile power source 520 and processor 210. Power unit 720 may further include any combination of elements previously discussed that may be a part of wearable apparatus 110, including, but not limited to, wireless transceiver 530, feedback outputting unit 230, memory 550, and data port 570.

Connector 730 may include a clip 715 or other mechanical connection designed to clip or attach capturing unit 710 and power unit 720 to an article of clothing 750 as illustrated in FIG. 8. As illustrated, clip 715 may connect to each of capturing unit 710 and power unit 720 at a perimeter thereof, and may wrap around an edge of the article of clothing 750 to affix the capturing unit 710 and power unit 720 in place. Connector 730 may further include a power cable 760 and a data cable 770. Power cable 760 may be capable of conveying power from mobile power source 520 to image sensor 220 of capturing unit 710. Power cable 760 may also be configured to provide power to any other elements of capturing unit 710, e.g., orientation adjustment unit 705. Data cable 770 may be capable of conveying captured image data from image sensor 220 in capturing unit 710 to processor 800 in the power unit 720. Data cable 770 may be further capable of conveying additional data between capturing unit 710 and processor 800, e.g., control instructions for orientation adjustment unit 705.

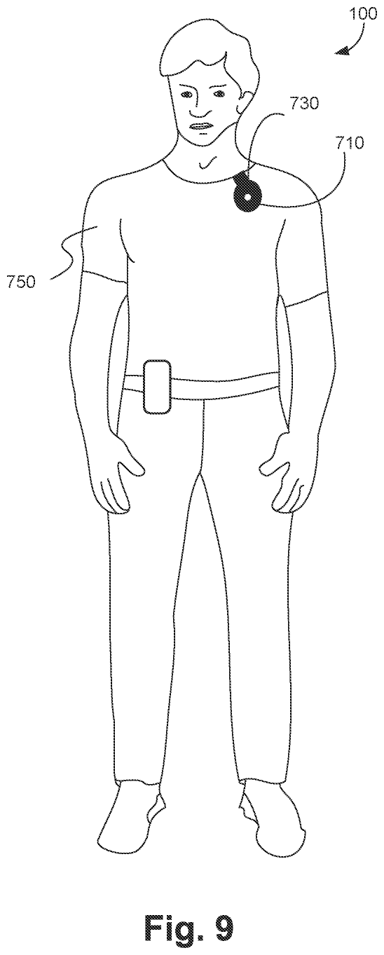

FIG. 9 is a schematic illustration of a user 100 wearing a wearable apparatus 110 consistent with an embodiment of the present disclosure. As illustrated in FIG. 9, capturing unit 710 is located on an exterior surface of the clothing 750 of user 100. Capturing unit 710 is connected to power unit 720 (not seen in this illustration) via connector 730, which wraps around an edge of clothing 750.

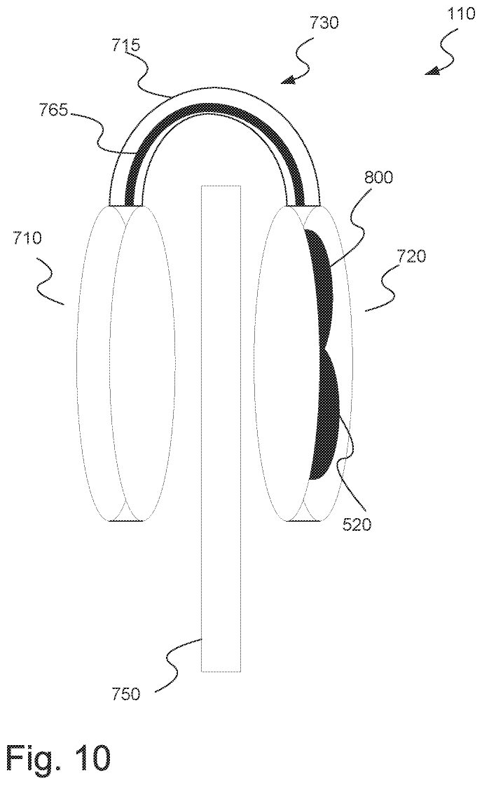

In some embodiments, connector 730 may include a flexible printed circuit board (PCB). FIG. 10 illustrates an exemplary embodiment wherein connector 730 includes a flexible printed circuit board 765. Flexible printed circuit board 765 may include data connections and power connections between capturing unit 710 and power unit 720. Thus, in some embodiments, flexible printed circuit board 765 may serve to replace power cable 760 and data cable 770. In alternative embodiments, flexible printed circuit board 765 may be included in addition to at least one of power cable 760 and data cable 770. In various embodiments discussed herein, flexible printed circuit board 765 may be substituted for, or included in addition to, power cable 760 and data cable 770.

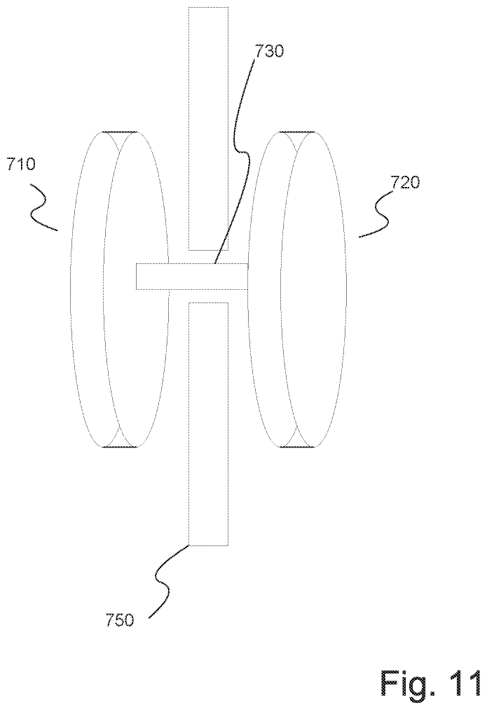

FIG. 11 is a schematic illustration of another embodiment of a wearable apparatus securable to an article of clothing consistent with the present disclosure. As illustrated in FIG. 11, connector 730 may be centrally located with respect to capturing unit 710 and power unit 720. Central location of connector 730 may facilitate affixing apparatus 110 to clothing 750 through a hole in clothing 750 such as, for example, a button-hole in an existing article of clothing 750 or a specialty hole in an article of clothing 750 designed to accommodate wearable apparatus 110.

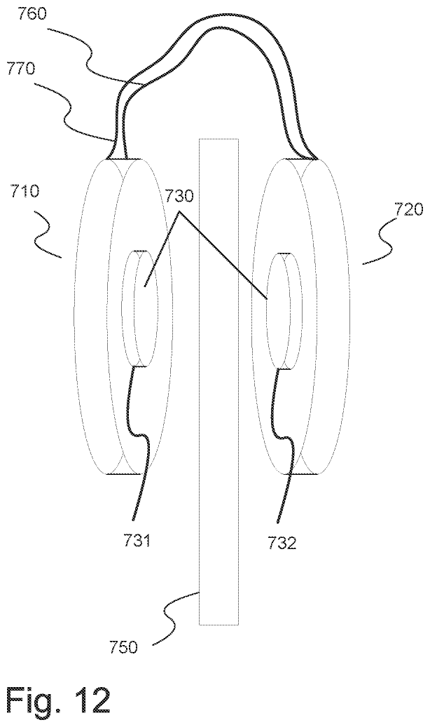

FIG. 12 is a schematic illustration of still another embodiment of wearable apparatus 110 securable to an article of clothing. As illustrated in FIG. 12, connector 730 may include a first magnet 731 and a second magnet 732. First magnet 731 and second magnet 732 may secure capturing unit 710 to power unit 720 with the article of clothing positioned between first magnet 731 and second magnet 732. In embodiments including first magnet 731 and second magnet 732, power cable 760 and data cable 770 may also be included. In these embodiments, power cable 760 and data cable 770 may be of any length, and may provide a flexible power and data connection between capturing unit 710 and power unit 720. Embodiments including first magnet 731 and second magnet 732 may further include a flexible PCB 765 connection in addition to or instead of power cable 760 and/or data cable 770. In some embodiments, first magnet 731 or second magnet 732 may be replaced by an object comprising a metal material.

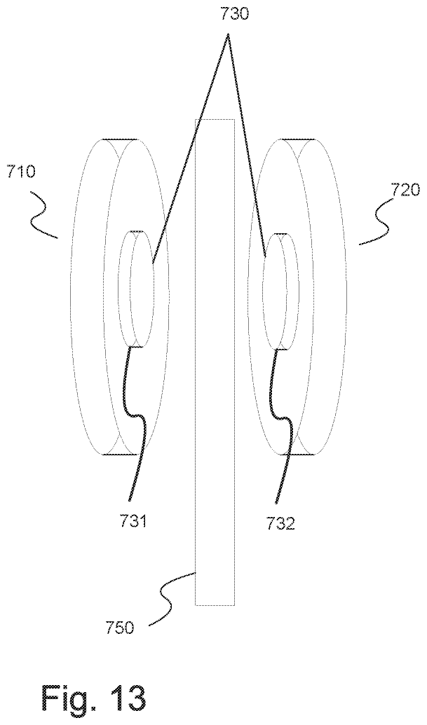

FIG. 13 is a schematic illustration of yet another embodiment of a wearable apparatus 110 securable to an article of clothing. FIG. 13 illustrates an embodiment wherein power and data may be wirelessly transferred between capturing unit 710 and power unit 720. As illustrated in FIG. 13, first magnet 731 and second magnet 732 may be provided as connector 730 to secure capturing unit 710 and power unit 720 to an article of clothing 750. Power and/or data may be transferred between capturing unit 710 and power unit 720 via any suitable wireless technology, for example, magnetic and/or capacitive coupling, near field communication technologies, radiofrequency transfer, and any other wireless technology suitable for transferring data and/or power across short distances.

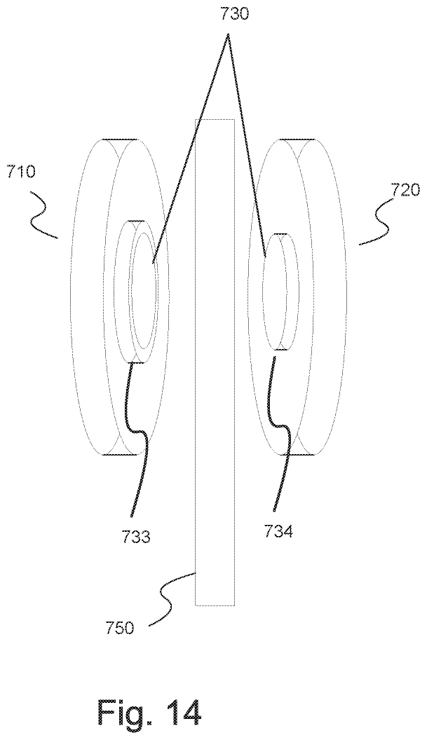

FIG. 14 illustrates still another embodiment of wearable apparatus 110 securable to an article of clothing 750 of a user. As illustrated in FIG. 14, connector 730 may include features designed for a contact fit. For example, capturing unit 710 may include a ring 733 with a hollow center having a diameter slightly larger than a disk-shaped protrusion 734 located on power unit 720. When pressed together with fabric of an article of clothing 750 between them, disk-shaped protrusion 734 may fit tightly inside ring 733, securing capturing unit 710 to power unit 720. FIG. 14 illustrates an embodiment that does not include any cabling or other physical connection between capturing unit 710 and power unit 720. In this embodiment, capturing unit 710 and power unit 720 may transfer power and data wirelessly. In alternative embodiments, capturing unit 710 and power unit 720 may transfer power and data via at least one of cable 760, data cable 770, and flexible printed circuit board 765.

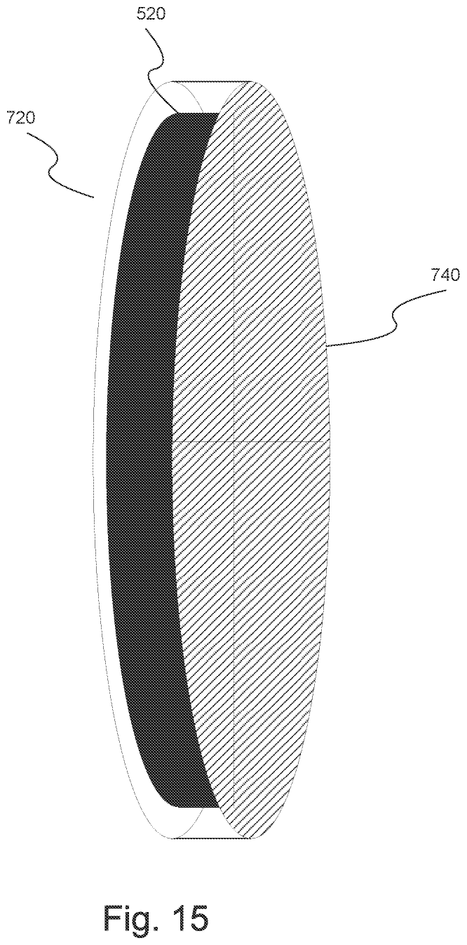

FIG. 15 illustrates another aspect of power unit 720 consistent with embodiments described herein. Power unit 720 may be configured to be positioned directly against the user's skin. To facilitate such positioning, power unit 720 may further include at least one surface coated with a biocompatible material 740. Biocompatible materials 740 may include materials that will not negatively react with the skin of the user when worn against the skin for extended periods of time. Such materials may include, for example, silicone, PTFE, kapton, polyimide, titanium, nitinol, platinum, and others. Also as illustrated in FIG. 15, power unit 720 may be sized such that an inner volume of the power unit is substantially filled by mobile power source 520. That is, in some embodiments, the inner volume of power unit 720 may be such that the volume does not accommodate any additional components except for mobile power source 520. In some embodiments, mobile power source 520 may take advantage of its close proximity to the skin of user's skin. For example, mobile power source 520 may use the Peltier effect to produce power and/or charge the power source.

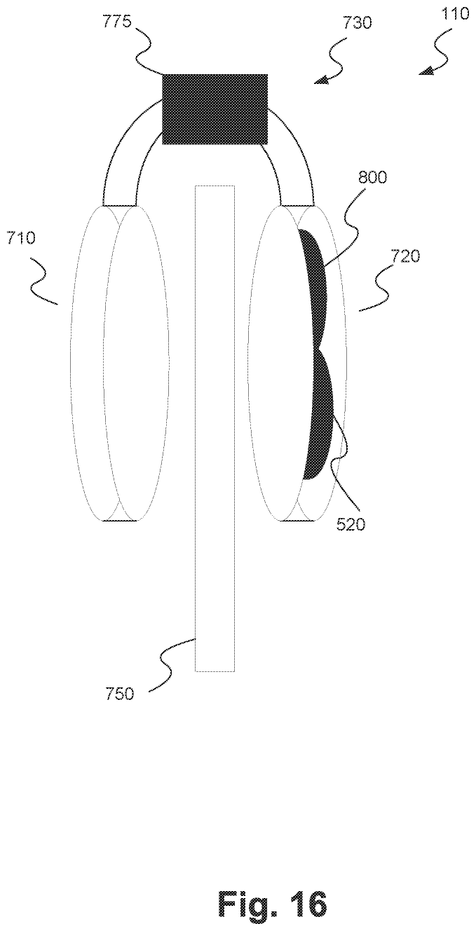

In further embodiments, an apparatus securable to an article of clothing may further include protective circuitry associated with power source 520 housed in in power unit 720. FIG. 16 illustrates an exemplary embodiment including protective circuitry 775. As illustrated in FIG. 16, protective circuitry 775 may be located remotely with respect to power unit 720. In alternative embodiments, protective circuitry 775 may also be located in capturing unit 710, on flexible printed circuit board 765, or in power unit 720.

Protective circuitry 775 may be configured to protect image sensor 220 and/or other elements of capturing unit 710 from potentially dangerous currents and/or voltages produced by mobile power source 520. Protective circuitry 775 may include passive components such as capacitors, resistors, diodes, inductors, etc., to provide protection to elements of capturing unit 710. In some embodiments, protective circuitry 775 may also include active components, such as transistors, to provide protection to elements of capturing unit 710. For example, in some embodiments, protective circuitry 775 may comprise one or more resistors serving as fuses. Each fuse may comprise a wire or strip that melts (thereby braking a connection between circuitry of image capturing unit 710 and circuitry of power unit 720) when current flowing through the fuse exceeds a predetermined limit (e.g., 500 milliamps, 900 milliamps, 1 amp, 1.1 amps, 2 amp, 2.1 amps, 3 amps, etc.) Any or all of the previously described embodiments may incorporate protective circuitry 775.

In some embodiments, the wearable apparatus may transmit data to a computing device (e.g., a smartphone, tablet, watch, computer, etc.) over one or more networks via any known wireless standard (e.g., cellular, Wi-Fi, Bluetooth®, etc.), or via near-filed capacitive coupling, other short range wireless techniques, or via a wired connection. Similarly, the wearable apparatus may receive data from the computing device over one or more networks via any known wireless standard (e.g., cellular, Wi-Fi, Bluetooth®, etc.), or via near-filed capacitive coupling, other short range wireless techniques, or via a wired connection. The data transmitted to the wearable apparatus and/or received by the wireless apparatus may include images, portions of images, identifiers related to information appearing in analyzed images or associated with analyzed audio, or any other data representing image and/or audio data. For example, an image may be analyzed and an identifier related to an activity occurring in the image may be transmitted to the computing device (e.g., the “paired device”). In the embodiments described herein, the wearable apparatus may process images and/or audio locally (on board the wearable apparatus) and/or remotely (via a computing device). Further, in the embodiments described herein, the wearable apparatus may transmit data related to the analysis of images and/or audio to a computing device for further analysis, display, and/or transmission to another device (e.g., a paired device). Further, a paired device may execute one or more applications (apps) to process, display, and/or analyze data (e.g., identifiers, text, images, audio, etc.) received from the wearable apparatus.

Some of the disclosed embodiments may involve systems, devices, methods, and software products for determining at least one keyword. For example, at least one keyword may be determined based on data collected by apparatus 110. At least one search query may be determined based on the at least one keyword. The at least one search query may be transmitted to a search engine.

In some embodiments, at least one keyword may be determined based on at least one or more images captured by image sensor 220. In some cases, the at least one keyword may be selected from a keywords pool stored in memory. In some cases, optical character recognition (OCR) may be performed on at least one image captured by image sensor 220, and the at least one keyword may be determined based on the OCR result. In some cases, at least one image captured by image sensor 220 may be analyzed to recognize: a person, an object, a location, a scene, and so forth. Further, the at least one keyword may be determined based on the recognized person, object, location, scene, etc. For example, the at least one keyword may comprise: a person's name, an object's name, a place's name, a date, a sport team's name, a movie's name, a book's name, and so forth.

In some embodiments, at least one keyword may be determined based on the user's behavior. The user's behavior may be determined based on an analysis of the one or more images captured by image sensor 220. In some embodiments, at least one keyword may be determined based on activities of a user and/or other person. The one or more images captured by image sensor 220 may be analyzed to identify the activities of the user and/or the other person who appears in one or more images captured by image sensor 220. In some embodiments, at least one keyword may be determined based on at least one or more audio segments captured by apparatus 110. In some embodiments, at least one keyword may be determined based on at least GPS information associated with the user. In some embodiments, at least one keyword may be determined based on at least the current time and/or date.

In some embodiments, at least one search query may be determined based on at least one keyword. In some cases, the at least one search query may comprise the at least one keyword. In some cases, the at least one search query may comprise the at least one keyword and additional keywords provided by the user. In some cases, the at least one search query may comprise the at least one keyword and one or more images, such as images captured by image sensor 220. In some cases, the at least one search query may comprise the at least one keyword and one or more audio segments, such as audio segments captured by apparatus 110.

In some embodiments, the at least one search query may be transmitted to a search engine. In some embodiments, search results provided by the search engine in response to the at least one search query may be provided to the user. In some embodiments, the at least one search query may be used to access a database.

For example, in one embodiment, the keywords may include a name of a type of food, such as quinoa, or a brand name of a food product; and the search will output information related to desirable quantities of consumption, facts about the nutritional profile, and so forth. In another example, in one embodiment, the keywords may include a name of a restaurant, and the search will output information related to the restaurant, such as a menu, opening hours, reviews, and so forth. The name of the restaurant may be obtained using OCR on an image of signage, using GPS information, and so forth. In another example, in one embodiment, the keywords may include a name of a person, and the search will provide information from a social network profile of the person. The name of the person may be obtained using OCR on an image of a name tag attached to the person's shirt, using face recognition algorithms, and so forth. In another example, in one embodiment, the keywords may include a name of a book, and the search will output information related to the book, such as reviews, sales statistics, information regarding the author of the book, and so forth. In another example, in one embodiment, the keywords may include a name of a movie, and the search will output information related to the movie, such as reviews, box office statistics, information regarding the cast of the movie, show times, and so forth. In another example, in one embodiment, the keywords may include a name of a sport team, and the search will output information related to the sport team, such as statistics, latest results, future schedule, information regarding the players of the sport team, and so forth. For example, the name of the sports team may be obtained using audio recognition algorithms.

A wearable apparatus consistent with the disclosed embodiments may be used in social events to identify individuals in the environment of a user of the wearable apparatus and provide contextual information associated with the individual. For example, the wearable apparatus may determine whether an individual is known to the user, or whether the user has previously interacted with the individual. The wearable apparatus may provide an indication to the user about the identified person, such as a name of the individual or other identifying information. The device may also extract any information relevant to the individual, for example, words extracted from a previous encounter between the user and the individual, topics discussed during the encounter, or the like. The device may also extract and display information from external source, such as the internet. Further, regardless of whether the individual is known to the user or not, the wearable apparatus may pull available information about the individual, such as from a web page, a social network, etc. and provide the information to the user.

This content information may be beneficial for the user when interacting with the individual. For example, the content information may remind the user who the individual is. For example, the content information may include a name of the individual, or topics discussed with the individual, which may remind the user of how he or she knows the individual. Further, the content information may provide talking points for the user when conversing with the individual. for example, the user may recall previous topics discussed with the individual, which the user may want to bring up again. In some embodiments, for example where the content information is derived from a social media or blog post, the user may bring up topics that the user and the individual have not discussed yet, such as an opinion or point of view of the individual, events in the individual's life, or other similar information. Thus, the disclosed embodiments may provide, among other advantages, improved efficiency, convenience, and functionality over prior art devices.

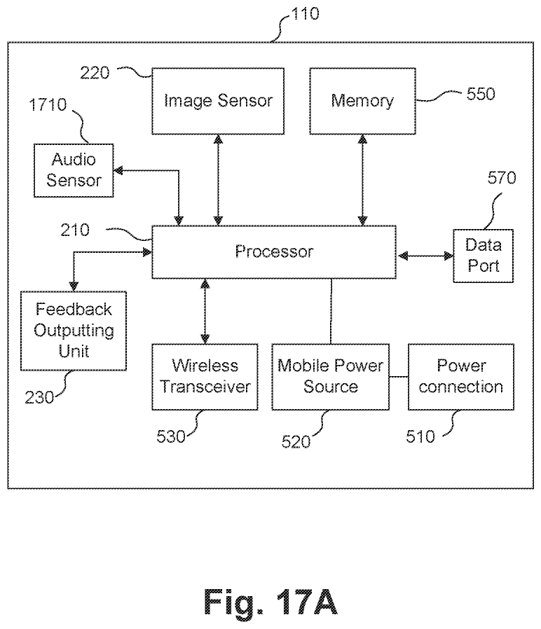

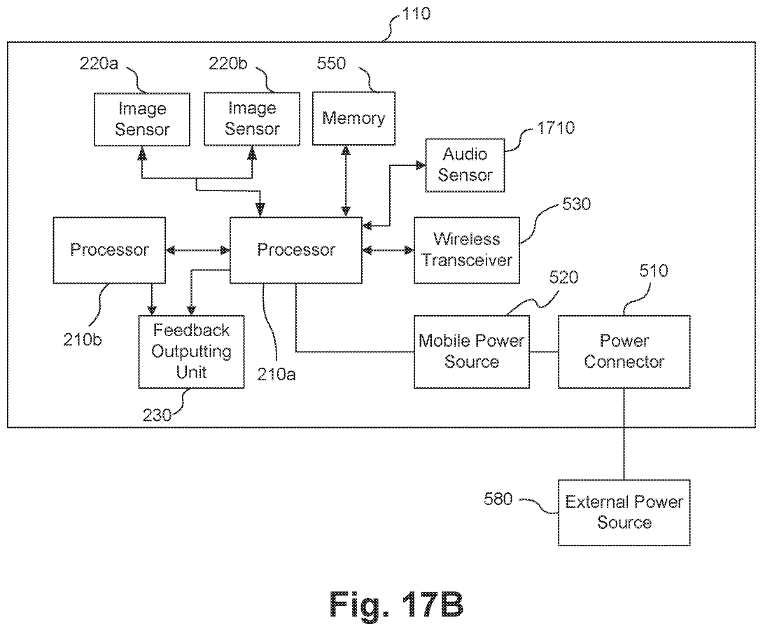

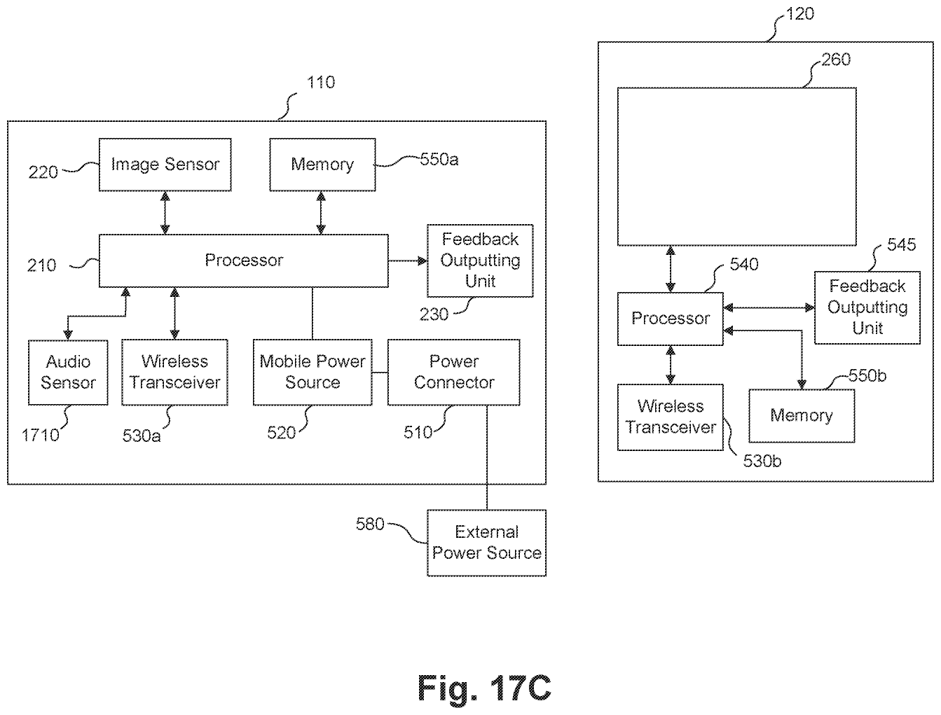

In some embodiments, apparatus 110 may be configured to use audio information in addition to image information. For example, apparatus 110 may detect and capture sounds in the environment of the user, via one or more microphones. Apparatus 110 may use this audio information instead of, or in combination with, image information to determine situations, identify persons, perform activities, or the like. FIG. 17A is a block diagram illustrating components of wearable apparatus 110 according to an example embodiment. FIG. 17A may include the features shown in FIG. 5A. For example, as discussed in greater detail above, wearable apparatus may include processor 210, image sensor 220, memory 550, wireless transceiver 530 and various other components as shown in FIG. 17A. Wearable apparatus may further comprise an audio sensor 1710. Audio sensor 1710 may be any device capable of capturing sounds from an environment of a user and converting them to one or more audio signals. For example, audio sensor 1710 may comprise a microphone or another sensor (e.g., a pressure sensor, which may encode pressure differences comprising sound) configured to encode sound waves as a digital signal. As shown in FIG. 17A, processor 210 may analyze signals from audio sensor 1710 in addition to signals from image sensor 220.

FIG. 17B is a block diagram illustrating the components of apparatus 110 according to another example embodiment. Similar to FIG. 17A, FIG. 17B includes all the features of FIG. 5B along with audio sensor 1710. Processor 210a may analyze signals from audio sensor 1710 in addition to signals from image sensors 210a and 210b. In addition, although FIGS. 17A and 17B each depict a single audio sensor, a plurality of audio sensors may be used, whether with a single image sensor as in FIG. 17A or with a plurality of image sensors as in FIG. 17B.

FIG. 17C is a block diagram illustrating components of wearable apparatus 110 according to an example embodiment. FIG. 17C includes all the features of FIG. 5C along with audio sensor 1710. As shown in FIG. 17C, wearable apparatus 110 may communicate with a computing device 120. In such embodiments, wearable apparatus 110 may send data from audio sensor 1710 to computing device 120 for analysis in addition to or in lieu of analyze the signals using processor 210.

Wearable Apparatus for Projecting Information

As described above, audio and image signals captured from within the environment of a user may be processed prior to presenting them to the user. This processing may include various types of conditioning or enhancements of the audio to improve the experience for the user. For example, in any of the configurations described above, whether the device comprises a speaker, transmits audio to an external device, transmits audio to a hearing aid or the like, additional information associated with the source of the audio may be provided to a user, such as, but not limited to, the name of a person who is the source of the audio.

In some embodiments, a system in accordance with the disclosure may analyze one or more captured images to detect an individual in the images. The disclosed hearing aid system may determine additional information regarding the individual, for example, a name of the individual. The disclosed system may provide the additional information to the user. In some embodiments, the additional information may be provided to the user by displaying the information (e.g., projecting the information) on a surface in the environment of the user.

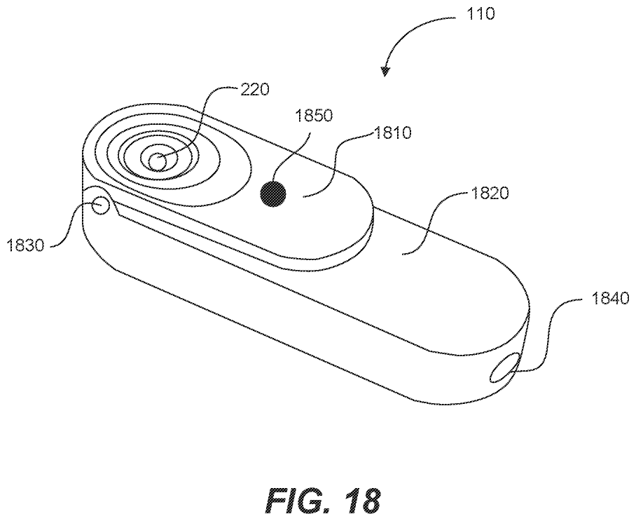

In some embodiments, user 100 may wear a wearable apparatus (e.g., similar to the camera-based hearing aid device discussed above). FIG. 18 illustrates another embodiment of wearable apparatus 110 securable to an article of clothing of a user. Consistent with the disclosed embodiments, apparatus 110 may be positioned in other locations, as described previously. For example, apparatus 110 may be physically connected to a shirt, a necklace, a belt, glasses, a wrist strap, a button, etc. Apparatus 110 may be configured to communicate with a hearing aid device (e.g., 230) similar to the camera-based hearing aid device discussed above. In one embodiment, the hearing aid device may include one or more speakers for providing audible feedback to user 100, a communication unit for receiving signals from another system, such as apparatus 110, microphones for detecting sounds in the environment of user 100, internal electronics, processors, memories, etc. In some embodiments, the hearing aid device may correspond to feedback outputting unit 230 or may be separate from feedback outputting unit 230 and may be configured to receive signals from feedback outputting unit 230.

In some embodiments, the hearing aid device may be placed in one or both ears of user 100, similar to traditional hearing interface devices. In other embodiments, hearing aid device may comprise a bone conduction headphone that may be surgically implanted and may provide audible feedback to user 100 through bone conduction of sound vibrations to the inner ear. In other embodiments, the hearing aid device may be of various styles, including in-the-canal, completely-in-canal, in-the-ear, behind-the-ear, on-the-ear, receiver-in-canal, open fit, or various other styles. The hearing aid device may also comprise one or more headphones (e.g., wireless headphones, over-ear headphones, etc.) or a portable speaker carried or worn by user 100. In some embodiments, hearing aid device may be integrated into other devices, such as a Bluetooth™ headset of the user, glasses, a helmet (e.g., motorcycle helmets, bicycle helmets, etc.), a hat, etc. However, in some embodiments the wearable apparatus may comprise or connect to a speaker rather than communicate with a hearing aid interface.

In some embodiments, the wearable apparatus may include an image sensor configured to capture a plurality of images from an environment of a user. As illustrated in FIG. 18, capturing unit 1810 includes image sensor 220 that may be part of a camera included in apparatus 110. It is contemplated that image sensor 220 may be associated with a variety of cameras, for example, a wide angle camera, a narrow angle camera, an IR camera, etc. In some embodiments, the camera may include a video camera. The one or more cameras may be configured to capture images from the surrounding environment of user 100 and output an image signal. For example, the one or more cameras may be configured to capture individual still images or a series of images in the form of a video. The one or more cameras may be configured to generate and output one or more image signals representative of the one or more captured images. In some embodiments, the image signal includes a video signal. For example, when image sensor 220 is associated with a video camera, the video camera may output a video signal representative of a series of images captured as a video image by the video camera.

In some embodiments the disclosed system may include at least one microphone configured to capture sounds from the environment of the user. As discussed above, apparatus 110 may also include one or more microphones to receive one or more sounds associated with the environment of user 100. For example, apparatus 110 may comprise microphones 443, 444, as described with respect to FIGS. 4F and 4G. Microphones 443 and 444 may be configured to obtain environmental sounds and voices of various speakers communicating with user 100 and output one or more audio signals. Microphones 443, 444 may comprise one or more directional microphones, a microphone array, a multi-port microphone, or the like. The microphones shown in FIGS. 4F and 4G are by way of example only, and any suitable number, configuration, or location of microphones may be used.

In some embodiments, the camera and the at least one microphone are each configured to be worn by the user. By way of example, user 100 may wear an apparatus 110 that may include a camera (e.g., image sensor system 220) and/or one or more microphones 443, 444 (See FIGS. 2, 3A, 4D, 4F, 4G). In some embodiments the camera and the microphone are included in a common housing. By way of example, as illustrated in FIGS. 4D, 4F, and 4G, the one or more image sensors 220 and microphones 443, 444 may be included in body 435 (common housing) of apparatus 110. In some embodiments, the common housing is configured to be worn by a user. For example, as illustrated in FIGS. 1B, 1C, 1D, 4C, and 9, user 100 may wear apparatus 110 that includes common housing or body 435 (see FIG. 4D).

As illustrated in FIG. 18, capturing unit 1810 may be connected to power unit 1820 by one or more hinges, e.g., hinge 1830, such that capturing unit 1810 is positioned on one side of an article of clothing and power unit 1820 is positioned on the opposite side of the clothing. Power unit 1820 may include a connector 1840 (e.g., a plug) configured to receive a cable for transferring data and/or power to apparatus 110. In some embodiments, wearable apparatus 110 may further include one or more speakers (not shown).

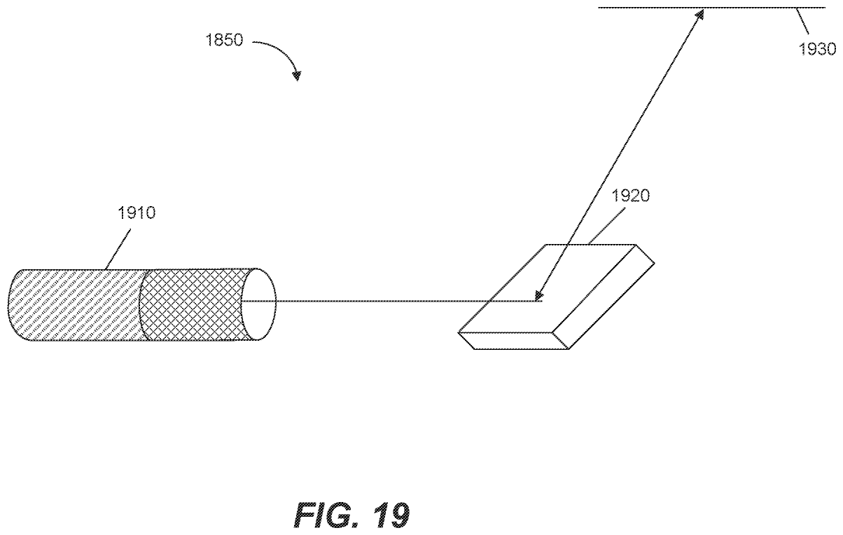

In some embodiments the wearable apparatus may include a light projector. In some embodiments the light projector may include a light source configured to emit light. For example, as also illustrated in FIG. 18, wearable apparatus 110 may include projection component 1850. Projection component 1850 may be configured to project one or more informational images including additional information regarding an individual or an object present in an environment of the user. FIG. 19 illustrates an exemplary projection component 1850 consistent with the present disclosure. Projection component or light projector 1850 may include light source 1910 and one or more reflectors 1920 configured to direct light received from light source 1910 onto a projection surface 1930. In some embodiments, the light source may be a laser emitter. For example, light source 1910 may include one laser source for monochromatic projection, or multiple laser sources, for example, red, green, and blue sources for color projection. It is contemplated that in some exemplary embodiments, light source 1910 may be configured to emit other types of light such as monochrome or multi-color visible light. In some embodiments, the light projector may include a reflector configured to direct the emitted light onto a surface. For example, light projector 1850 may include one or more reflectors 1920 to reflect light received from light source 1910 onto projection surface 1930. In some embodiments, the reflector includes at least one MEMS mirror. For example, the one or more reflectors 1920 may include one or more MEMS mirrors for directing a projection from light source 1910 in a desired direction, and one or more controllers (not shown) that control the lasers 1910 and/or mirrors 1920.

In some embodiments, the wearable apparatus may include at least one processor. By way of example, as discussed above, apparatus 110 may include processor 210 (see FIG. 5A). As also discussed above, processor 210 may include any physical device having an electric circuit that performs a logic operation on input or inputs. Processor 210 may be configured to control operations of the various components (e.g., camera sensor 220, projection component 1850, etc.). It is also contemplated that in some embodiments, projection component 1850 may include a processor different from processor 210 for controlling one or more of light sources 1910 and/or mirrors 1920. For example, processor 210 and/or a processor of projection component 1850 may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. Further, in some embodiments, wearable apparatus 110 may contain all its components inside a housing. Thus, for example, image sensor 220, projection component 1850, microphones 443, 444, etc., may all be located within a single housing of wearable apparatus 110.

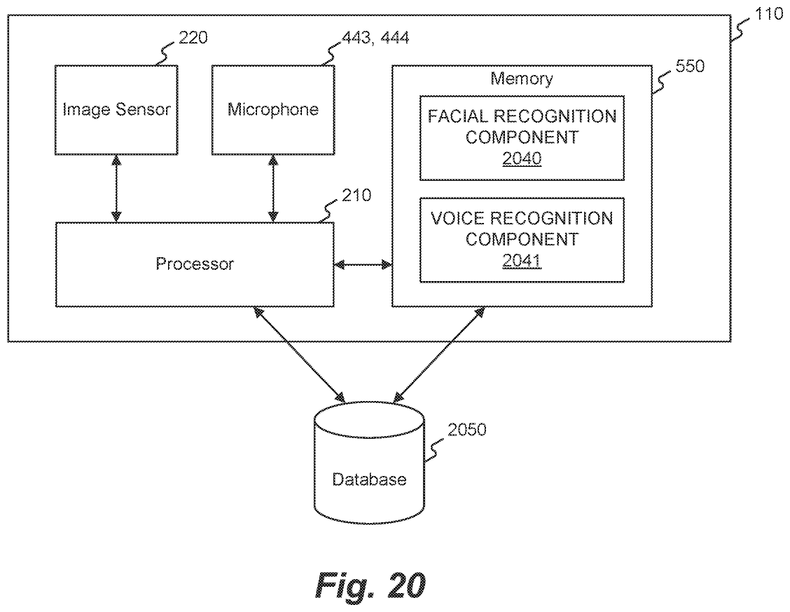

In some embodiments, the at least one processor may be programmed to receive at least one image of the plurality of images. In some embodiments, the at least one processor may also be programed to receive at least one audio signal representative of the sounds captured by the at least one microphone. For example, processor 210 of apparatus 110 may receive one or more images captured by the one or more cameras or image sensors 220 and one or more audio signals captured by the one or more microphones 443 or 444. Processor 210 may be configured to analyze the captured images and detect a recognized individual using various facial recognition techniques or voice recognition techniques. Accordingly, apparatus 110, or specifically memory 550, may comprise one or more facial or voice recognition components as discussed above with reference to FIG. 20. Although the following disclosure may refer to processor 210, it is to be understood that processes performed by processor 210 may be performed in whole or in part by other processors such as processors 210a, 210b, 540 discussed above.

FIG. 20 illustrates an exemplary embodiment of apparatus 110 comprising facial and voice recognition components consistent with the present disclosure. Apparatus 110 is shown in FIG. 20 in a simplified form, and apparatus 110 may contain additional elements or may have alternative configurations, for example, as shown in FIGS. 5A-5C. Memory 550 (or 550a or 550b) may include facial recognition component 2040 and voice recognition component 2041. These components may be instead of or in addition to orientation identification module 601, orientation adjustment module 602, and motion tracking module 603 as shown in FIG. 6. Components 2040 and 2041 may contain software instructions for execution by at least one processing device, e.g., processor 210, included with a wearable apparatus. Components 2040 and 2041 are shown within memory 550 by way of example only, and may be located in other locations within the system. For example, components 2040 and 2041 may be located in a hearing aid device, in computing device 120, on a remote server, or in another associated device.

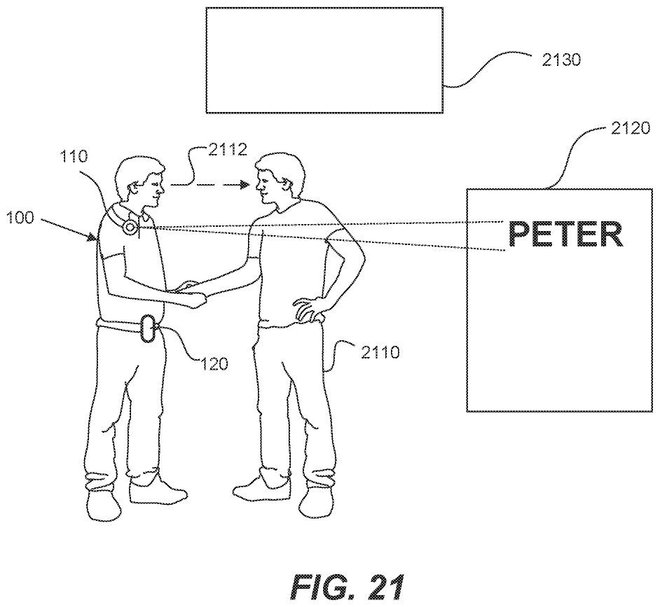

In some embodiments, the processor may be programmed to detect a face in the at least one image. In particular, the processor may be programmed to identify the at least one individual by recognizing a face of the at least one individual. For example, facial recognition component 2040 may be configured to identify one or more faces within the environment of user 100. By way of example, facial recognition component 2040 may identify facial features, such as the eyes, nose, cheekbones, jaw, or other features, on a face of an individual as represented in an image received by wearable apparatus 110. Facial recognition component 2040 may then analyze the relative size and position of these features to identify the user. Facial recognition component 2040 may use one or more of the techniques described above to identify an individual (e.g. 2110, FIG. 21) in the one or more images. For example, facial recognition component 2040 may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), or the like.

In some embodiments, the at least one processor may be programmed to compare the face to a plurality of faces stored in a database. Facial recognition component 2040 may access a database or data associated with user 100 to determine if the detected facial features correspond to a recognized individual. For example, processor 210 may access database 2050 containing information about individuals known to user 100 and data representing associated facial features or other identifying features. Processor 210 may be configured to compare one or more faces (e.g., facial features) identified in the one or more images captured by image sensor 220 with a plurality of faces (and facial features) stored in database 2050. Processor 210 may be configured to identify an individual in the one or more images captured by image sensor 220 when a face in the captured images matches, for example, one or more faces stored in database 2050. Other data or information may also inform the facial identification process. In some embodiments, processor 210 may determine a user's looking direction, which may be used to verify the identity of individual 2010. For example, if user 100 is looking in the direction of individual 2110 (see FIG. 21) (especially for a prolonged period, e.g., a time period that equals or exceeds a predetermined threshold of time), this may indicate that individual 2110 is recognized by user 100, which may be used to increase the confidence of facial recognition component 2040 or other identification means.

In some embodiments, processor 210 may use various techniques to recognize the voice of an individual 2110 (see FIG. 21). The recognized voice pattern or characteristics and the detected facial features may be used, either alone or in combination, to determine that individual 2110 is recognized by apparatus 110. For example, processor 210 may analyze audio signals representative of sound captured by microphones 443 or 444 to determine whether individual 2110 is recognized by user 100. This may be performed using voice recognition component 2041 (FIG. 20) and may include one or more voice recognition algorithms, such as Hidden Markov Models, Dynamic Time Warping, neural networks, or other techniques. Voice recognition component and/or processor 210 may access database 2050, which may include a voiceprint of one or more individuals. Voice recognition component 2041 may analyze the audio signal representative of a sound in an environment of user 100 to determine whether the voice in the audio signal received from microphones 443, 444 matches a voiceprint of an individual in database 2050. After determining a match, individual 2110 may be determined to be a recognized individual of user 100. This process may be used alone, or in conjunction with the facial recognition techniques described above. For example, individual 2110 may be recognized using facial recognition component 2040 and may be verified using voice recognition component 2041, or vice versa.

In some embodiments, one identification method may be used. If the confidence level is above a first predetermined threshold, identification may be determined. If the confidence level is below a second predetermined threshold, it may be determined that the individual is not recognized. If the confidence level is between the first and the second predetermined thresholds, the second identification method may be employed. By way of example, individual 2110 may be recognized using facial recognition component 2040. A confidence level associated with identification of individual 2010 may be determined. If the determined confidence level exceeds a first predetermined threshold confidence level, identification of individual 2110 may be confirmed. If, however, the determined confidence level is below a second predetermined threshold confidence level, processor 210 may determine that individual 2110 has not been identified. If the determined confidence level lies between the first and second predetermined threshold confidence levels, processor 210 may employ voice recognition component 2041 to recognize individual 2110.

In some embodiments, the at least one processor may be programmed to identify an item of information based on the at least one image. In other embodiments, the at least one processor may be programmed to determine the item of information based on the comparison of the face detected in the at least one image to a plurality of faces stored in a database. In yet other embodiments, the at least one processor may be programmed to identify the item of information based on the at least one image and the at least one audio signal. For example, processor 210 may be configured to identify an item of information associated with the individual recognized using either or both of the one or more images obtained by apparatus 110 via image sensor 220 or audio captured by microphones 443, 444. In some embodiments, processor 210 may be configured to identify the item of information based on information stored in database 2050. In some embodiments, database 2050 may be associated with a social network platform, such as Facebook™, LinkedIn™, Instagram™, etc. Facial recognition component 2040 may also access a contact list of user 100, such as a contact list on the user's phone, a web-based contact list (e.g., through Outlook™, Skype™, Google™, SalesForce™, etc.) or a dedicated contact list associated with user 100 to determine the item of information.

In some embodiments, the item of information includes at least one of a name of a person within the field of view of the user, a location, a phone number associated with the person, a time, or a date. By way of example, identifying the information may include determining at least one of an identity of an individual (e.g., a name), a location, or an object in the at least one image. As also discussed above, processor 210 may be configured to recognize the individual based on voice recognition. Thus, in some embodiments, the item of information may include an identity of an individual determined by identifying a voice of the individual using the at least one audio signal. For example, the item of information may include a name of the individual whose voice is identified using the audio signal by processor 210. The item of information may additionally or alternatively include a description of the recognized individual, a telephone number associated with the recognized individual, a time or location where the user may have previously interacted with the recognized individual, or social relationships between the user and the recognized individual, etc. In some embodiments, the item of information may also include, for example, a current location, details such as the last time user 100 met with the recognized individual, a location of the previous meeting, or one or more words or topics identified in a previous conversation between user 100 and the recognized individual, etc. For example, processor 210 may determine that the recognized individual is a first, second, or third connection of the user, a friend of the user, a relative of the user, a professional contact of the user, etc., via accessing a database and/or one or more of the social media platforms such as Facebook™, LinkedIn™, Instagram™, etc. In some embodiments, processor 210 may determine the item of information based on, for example, one or more contact lists of user 100, previous text or audio communications exchanged between the user and the recognized individual, etc. It is contemplated that processor 210 may determine the item of information based on various other sources such as blogs, newspaper or magazine articles, social media posts, whether authored by user 100, the recognized individual, and/or other authors, etc. It is also contemplated that in some embodiments, the item of information may include a current date and/or time at which user 100 may be interacting with a recognized individual in the user's environment. Processor 210 may be configured to determine the date and/or time using clocks or timers associated with processor 210 or based on information stored in database 2050. In some embodiments, processor 210 may determine the date and/or time based on information received from a secondary device, for example, a user device such as a laptop or desktop computer, smartphone, smartwatch, tablet computer, or other computing device associated with user 100.

In some embodiments the processor may be configured to identify the item of information by identifying a product in the at least one image. For example, although the above description discloses how processor 210 may identify an individual using the one or more images obtained via image sensor 220 or audio captured by one or more microphones 443, 444, it is contemplated that processor 210 may additionally or alternatively identify one or more objects and/or locations in the one or more images obtained by image sensor 220. For example, processor 210 may be configured to detect edges and/or surfaces associated with one or more objects in the one or more images obtained via image sensor 220. Processor 210 may use various algorithms including, for example, localization, image segmentation, edge detection, surface detection, feature extraction, etc., to detect one or more objects in the one or more images obtained via image sensor 220. It is contemplated that processor 210 may additionally or alternatively employ algorithms similar to those used for facial recognition to detect objects in the one or more images obtained via camera 1730. In some embodiments, processor 210 may be configured to compare the one or more detected objects with images or information associated with a plurality of objects stored in, for example, database 2050. Processor 210 may be configured to identify the one or more detected objects based on the comparison. For example, processor 210 may identify objects such as a name tag worn by an individual, a barcode on an object, a hoarding, a sign or display, a street sign, a table, a chair, a shelf, a cupboard, a column or pillar, etc. in the one or more images obtained by camera 1730. It is to be understood that this list of objects is non-limiting and processor 210 may be configured to identify other objects that may be encountered by user 100 in the user's environment.

In some embodiments, the item of information may be associated with a product located in the field of view of the user. Processor 210 may be configured to identify an item of information associated with the detected object (e.g., product). For example, processor 210 may access information stored in database 2050 to determine an identity of the object (e.g., identify an object as a table, a chair, etc.) Additionally or alternatively, processor 210 may be configured to identify a size, a shape, a color, a texture, a surface characteristic, and/or a location of the object based on analysis of the one or more images obtained via camera 1730. Some or all of these characteristics (e.g., size, shape color, etc.) of a detected object may be included in the item of information. In some embodiments, processor 210 may be configured to identify and extract textual information associated with the detected object.

In some embodiments, the at least one processor may be programmed to identify the item of information by identifying a street sign in the at least one image. For example, processor 210 may identify a text on a name tag, a street sign, a sign, or display, etc. Processor 210 may extract the text (e.g., using one or more optical character recognition techniques) and identify the text as an item of information to be provided to user 100. In some embodiments processor 210 may be configured to identify a barcode in the object. Processor 210 may access, for example, database 2050 to identify additional information associated with the identified barcode. In some exemplary embodiments, the at least one processor may be programmed to search for stores selling the product. For example, processor 210 may access database 2050 and/or one or more external repositories of information (e.g., Facebook, Google, store websites, online merchant websites, etc.) to determine sellers (online or otherwise) that may be selling the object or product identified in the image. In some exemplary embodiments, the at least one processor may be programmed to determine prices for the product in the stores selling the product and set the determined prices as the item of information. For example, processor 210 may be configured to obtain pricing information for the object from merchants identified as sellers of the object or product seen in the image. Processor 210 may identify the one or more prices of the object as the one or more items of information associated with the object.

In some embodiments, processor 210 may be configured to identify a location based on the one or more images and/or the one or more objects detected in the images. For example, processor 210 may be configured to compare the one or more images obtained by image sensor 220 with images stored in database 2050. In some embodiments, the at least one processor may be programmed to identify the item of information by searching for a street name associated with the street sign in a plurality of maps stored in a database. Processor 210 may also be configured to determine a location, for example, a street, a town or city, a neighborhood or section of the city (e.g., Soho or Chinatown) based on the comparison. In other embodiments, processor 210 may be configured to determine the location based on textual information extracted from the one or more detected objects, for example, a street sign. For example, processor 210 may be configured to compare the extracted textual information with textual information stored in database 2050 to identify the location. In some embodiments, the processor may be programmed to identify the item of information by selecting a map associated with the street sign based on the searching. For example, processor 210 may access database 2050 and select one or more maps associated with the street sign based on, for example, the textual information extracted from the image. In some embodiments, the processor may be programmed to set the selected one or more maps as the one or more items of information. Thus, for example, processor 210 may identify a map associated with the street sign from the one or more maps selected from database 2050. Processor 210 may identify that map as an item of information to be provided to user 100. As another example, processor 210 may identify the determined location associated with the street sign as an item of information to be provided to user 100.

In some embodiments, the at least one processor may be programmed to transmit the at least one image to a mobile device associated with a user, and receive the item of information from the mobile device. By way of example, processor 210 may be configured to transmit one or more images captured by, for example, image sensor 220 to optional computing device 120, server 250, and/or to a secondary computing device (e.g., mobile phone, smartphone, smartwatch, laptop computer, desktop computer, tablet computer, etc.) associated with user 100. One or more processors associated with optional computing device 120, server 250, and/or the secondary computing device associated with user 100 may perform operations similar to those discussed above with respect to processor 210 to identify one or more items of information associated with, for example, an individual or an object recognized in the one or more images. Computing device 120, server 250, and/or the secondary computing device associated with user 100 may be configured to transmit the one or more items of information to processor 210 for projecting or displaying the one or more items of information to user 100.

In some embodiments, the at least one processor may be programmed to select a surface located within a field of view of the user. Image analysis performed over the captured images may include the detection of a surface within the field of view of the user, for example a surface that is substantially perpendicular to the line of sight of the user. For example, as explained above, processor 210 may be configured to determine a looking direction of user 100. In some embodiments, the processor may be programmed to identify a plurality of surfaces within a field of view of the user for projecting the informational image. For example, processor 210 may be configured to identify one or more surfaces positioned directly in the looking direction of user 100 or adjacent to the looking direction. Processor 210 may define the field of view of user 100 based on a range of directions around the looking direction of user 100. By way of example, the range of directions may include directions within any suitable angle (e.g., 10 degrees, 20 degrees, 45 degrees) around the looking direction of the user (e.g., left side, right side, up, down, or other orientations relative to the looking direction, etc.). Processor 210 may identify one or more surfaces in the field of view of user 100. Processor 210 may be configured to use various algorithms including, for example, localization, image segmentation, edge detection, surface detection, feature extraction, object-space methods, depth-buffer methods, etc., to detect the one or more surfaces in the one or more images obtained from the environment of the user. By way of example, FIG. 21 illustrates environment 2100 that includes user 100 and individual 2110. As illustrated in FIG. 21, processor 210 may identify surface 2120 that may be in looking direction 2122 of user 100 and that may be behind individual 2110. For example, surface 2120 may be a wall in front of user 100. By way of another example, processor 210 may identify surface 2130 that may be a wall located on one side of user 100 for example within a range of directions of looking direction 2122.

In some exemplary embodiments, the one or more surfaces may include a portion of a hand of the user (e.g., palm, back of hand, wrist, forearm, etc.), a top surface of a desk, a wall the user is facing, a whiteboard or chalkboard, a door, a surface of a cupboard or cabinet, a surface of a shelf, a portion of the ceiling, or the like. In some embodiments, when more than one surface is identified by processor 210, processor 210 may be configured to select a surface from among the plurality of identified surfaces. For example, in some embodiments, processor 210 may be programmed to analyze the one or more images obtained by image sensor 220. Processor 210 may detect a looking direction of user 100 based on the analysis of the one or more images. Processor 210 may select a surface (e.g., 2120) that may be in front of user 100 but behind a recognized individual or an object (e.g., wall 2120) based on a looking direction of user 100. In other embodiments, processor 210 may be configured to select a surface at a distance from user 100 such that user 100 is able to read text on the surface without the need for glasses. In other embodiments, processor 210 may be configured to select the surface based on one or more of a size of the surface, a distance to the surface, an angle of the surface relative to the user, a smoothness or uniformity of the surface, a color of the surface, or the like. In yet other embodiments, processor 210 may be configured to select the surface based on the amount of information to be displayed. For example, if the information comprises only a name, then it may be displayed on the palm or wrist of the user, while if a larger amount of information is to be displayed, a part of a wall behind the individual may be preferred. In yet other embodiments, processor 210 may be configured to select the surface based on a user preference. For example, processor 210 may retrieve a user profile from database 2050. The user profile may specify, for example, colors, textures, uniformity, etc. of surfaces that user 100 prefers for projection of information. Processor 210 may select a surface for projection from the plurality of identified surfaces based on the user's preference.

In some embodiments, the at least one processor may be programmed to render the item of information into an informational image. For example, processor 210 may be configured to convert textual, audio, image, or other data associated with the item of information into an informational image. It is contemplated that the informational image may have any of various formats, for example, .jpg, .tiff, .gif, .bmp, .mov, .aa3, .aa4, etc. In some embodiments, the at least one processor may be programmed to cause the projector to project the informational image onto the surface. For example, processor 210 may cause projection component 1850 to project the informational image on a selected surface. Processor 210 may cause light source 1910 to initiate emission of light and may further adjust the one or more reflectors 1920 to direct the light from source 1910 onto the selected surface (e.g., surface 1930). By way of example, FIG. 21 illustrates projection of an informational image onto a selected surface (e.g., a wall, a floor, a ceiling, a table, an object, a screen, an article of clothing, such as shirt worn by a person, etc.). For example, processor 210 may use one or more techniques discussed above to identify individual 2110 as a recognized individual (e.g., someone known to user 100). Processor 210 may also identify a name, “PETER,” of individual 2110 as an item of information for display to user 100. Processor 210 may select surface 2120, which may be in a direct line of sight of user 100 and which may be behind individual 2110. Processor 210 may control light source 1910 and/or one or more reflectors 1920 to cause the name “PETER” to be projected on selected surface 2120 such that user 100 can see the name and avoid the awkward feeling of not recognizing individual 2110. Projecting information in this manner may also allow user 100 to view the information faster rather than having to pull out a mobile phone or other device to view the item of information. As discussed above, processor 210 may cause various items of information to be projected on surface 2120 and/or 2130 for user 100 to view. It is also contemplated that the item of information (e.g. informational image) may be projected for a short duration of time, for example, 1 second, 2 seconds, 10 seconds, or the like.

In some embodiments, the at least one processor may be programmed to identify at least one human or animal eye in the at least one image. For example, before projecting the informational image, processor 210 may be configured to determine whether it is safe to project the informational image onto the selected surface. For example, it may be beneficial to make sure the light projected from projected component 1850 does not impinge on an eye of individual 2110, another individual in environment 2100, a child in environment 2100, and/or a pet (e.g., dog, cat, etc.) present in environment 2100. Processor 210 may be configured to determine whether the one or more images captured by image sensor 220 includes an eye. Processor 210 may employ one or more of the algorithms discussed (e.g., facial recognition techniques) to identify one or more eyes in the one or more images captured by wearable apparatus 110. For example, processor 210 may compare portions of the one or more images captured by image sensor 220 with images of eyes stored, for example, in database 2050 to determine whether an eye is present in those images. In other embodiments, processor 210 may use a trained machine learning or neural network model to detect the presence of one or more eyes in the one or more images captured by image sensor 220.

In some embodiments, the processor may be programmed to determine whether the at least one eye is located between the projector and the surface. For example, processor 210 may determine a position of the detected eye relative to surfaces (e.g., 2120, 2130) and to projection component 1850 and/or user 100 based on the one or more images captured by image sensor 220. When processor 210 determines that the detected eye is located between user 100 and the one or more surface 2120 and 2130, processor 210 may determine whether light projected from projection component 1850 may impinge on the detected one or more eyes. Processor 210 may employ a variety of algorithms, such as, ray tracing, photon mapping, beam tracing, etc. to determine whether light emitted from projection component 1850 may impinge on the detected one or more eyes.

In some embodiments, the processor may be programmed to cause the projector to project the informational image when the eye is not located between the projector and the surface. For example, in some embodiments, processor 210 may be configured to either turn off light source 1910 and/or adjust the one or more reflectors 1920 such that light emitted by light source 1910 does not impinge on the one or more eyes detected in the one or more images obtained by wearable apparatus 100. In some embodiments, processor 210 may be configured to do so when it detects that the one or more eyes are located between user 100 and the one or more surfaces 2120 and/or 2130. In other embodiments, instead of turning off light source 1910, processor 210 may be configured to adjust the one or more reflectors 1920 to direct light away from the one or more of the detected eyes towards an alternate surface. For example, if processor 210 detects an eye (e.g., of a child or pet) between user 100 and surface 2120, processor 210 may adjust the one or more reflectors 1920 of projection component 1850 to divert the light from light source 1910 towards a different surface, for example, surface 2130. Thus, processor 210 may project the name “PETER” of individual 2110 on surface 2130 instead of on surface 2120.

In some embodiments, the at least one processor may be programmed to receive an input from the user indicating an approval or a disapproval for projecting the informational image, and subject to the input indicating an approval, cause the projector to project the informational image on to the surface. It is contemplated that in some embodiments, user 100 may be able to determine whether or not a suitable surface is available for projection. For example, when user 100 is in a large conference room where the nearest walls are too far away, it may not be possible for wearable apparatus 100 to project information so that user 100 can see it. Also, it may be determined, based on analyzing images and/or audio whether additional people are present in the environment, in which case projecting the information may be suppressed. In such situations, user 100 may activate one or more input devices (e.g. buttons, touch pads, switches, voice controls, etc.) to provide an input to processor 210 to allow or disallow projection of information. When user 100 provides an input indicating a disapproval for projecting the informational image, processor 210 may cause projection component 1850 to cease projecting the informational image by, for example, turning off light source 1910. When, however, user 100 provides an input indicating approval for projecting the informational image, processor 210 may cause light source 1910 to be switched on and adjust the one or more reflectors 1920, allowing projection component 1850 to project the informational image on a suitable surface (e.g., 2120 or 2130).

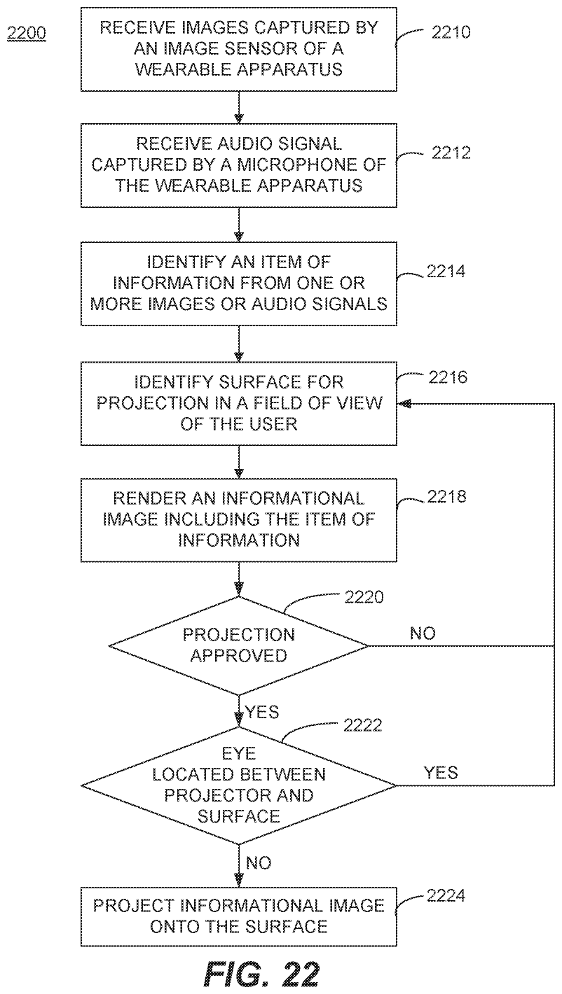

FIG. 22 is a flowchart showing an exemplary process 2200 for projecting information relevant to a recognized individual or product for the benefit of a user. Process 2200 may be performed by one or more processors associated with apparatus 110, such as processor 210. The processor(s) may be included in the same common housing as microphone 443, 444 and image sensor 220 (camera), which may also be used for process 2200. In some embodiments, some or all of process 2200 may be performed on processors external to apparatus 110, which may be included in a second housing. For example, one or more portions of process 2200 may be performed by processors in hearing aid device 230, or in an auxiliary device, such as computing device 120, server 250, or a secondary user device. In such embodiments, the processor may be configured to receive the captured images via a wireless link between a transmitter in the common housing and receiver in the second housing.

In step 2210, process 2200 may include receiving one or more images captured by an image sensor of a wearable apparatus. For example, the one or more images may be captured by a wearable camera such as a camera including image sensor 220 of apparatus 110. In step 2212, process 2200 may include receiving one or more audio signals representative of the sounds captured by a microphone from the environment of the user. For example, microphones 443, 444 may capture one or more sounds from an environment (e.g. 2100) of user 100.

In step 2214, process 2200 may include identifying an item of information based on at least one of the received at least one image or the received at least one audio signal. In step 2214, process 2200 may include identifying a representation of at least one individual or at least one object in at least one of the plurality of images. The individual and/or object may be identified using one or more image detection techniques such as segmentation, localization, edge and/or surface detection and/or one or more algorithms such as Haar cascade, histograms of oriented gradients (HOG), deep convolution neural networks (CNN), scale-invariant feature transform (SIFT), or the like. In step 2214, process 2200 may additionally or alternatively include identifying an individual or an object based on an analysis of the one or more audio signals received, for example, in step 2210. As discussed above, one or more voice recognition algorithms, such as Hidden Markov Models, Dynamic Time Warping, neural networks, or other techniques may be used to identify the individual or object based on an analysis of the one or more audio signals.

In step 2214, process 2200 may further include identifying an item of information associated with the detected individual and/or object. For example, processor 210 may use one or more techniques discussed above to identify one or more items of information associated with the identified individual or object. As discussed above, the one or more items of information may include a name, telephone number, age, social or other relationship with the user, address, profession, date, time, or place of the present interaction or last interaction with the user, words or topics from a previous conversation with the user, etc. For example, processor 210 may access database 2050, which may be associated with one or more social media platforms, and/or one or more contact lists of user 100 to determine the item of information. Additionally or alternatively, an identity of the object detected in the image, its location, etc. may be determined as an item of information. For example, as discussed above, processor 210 may compare the identified object with images of objects in database 2050 to determine the identity and/or location of the object.

In step 2216, process 2200 may include identifying a surface for projection in a field of view of the user. For example, as discussed above, processor 210 may be configured to identify a looking direction of user 100 and further identify one or more surfaces (e.g. 2120, 2130) etc., within a range of angles around the looking direction. As also explained above, in some embodiments the identified surfaces may include one or more of walls, surfaces of items, or a wrist, palm, hand, forearm, etc., of user 100. In step 2216, processor 210 may also select one of the surfaces from the plurality of identified surfaces for projecting an information image including an item of information. For example, as discussed above, processor 210 may select a surface based on a distance to the surface, an orientation of the surface, a color, roughness, uniformity or other characteristic of the surface, etc.

In step 2218, process 2200 may include a step of rendering an informational image including the item of information. For example, as explained above, processor 210 may be configured to convert any of textual, audio, and/or image data associated with the item of information into an informational image, which may have one of many formats (e.g., .jpg, .tiff, .gif, .bmp, .mov, .aa3, .aa4, etc.).

In step 2220, process 2200 may include a step of determining whether an input indicating approval or disapproval for projecting the informational image has been received from user 100. For example, as explained above, user 100 may use one or more input devices associated with wearable apparatus 110 to provide an input indicating whether or not projection component 1850 may project the informational image on a selected surface. In step 2220, when processor 210 determines that projection is approved (Step 2220, Yes), process 2200 may proceed to step 2222. In step 2220, when processor 210 determines, however, that projection is not approved (Step 2220, No) process 2200 may return to step 2216.

In step 2222, process 2200 may include a step of determining whether there is an eye located between projection component 1850 and the selected surface. For example, as explained above, processor 210 may determine whether the one or more images obtained by image sensor 220 include one or more eyes. Processor 210 may further determine positions of the detected one or more eyes relative to user 100 and the one or more surfaces (e.g., 2120, 2130). As further discussed above, processor 210 may determine whether the one or more eyes is located between projection component 1850 and one or more of surfaces (e.g., 2120, 2130). In step 2222, when processor 210 determines that the one or more eyes is located between projection component 1850 and one or more of the surfaces (Step 2222, Yes), process 2200 may return to step 2216 to identify an alternative surface for projection. In step 2222, when processor 210 determines, however, that the one or more eyes is not located between projection component 1850 and the one or more of surfaces (Step 2222, No), process 2200 may proceed to step 2224.

In step 2224, process 2200 may include a step of projecting the informational image onto a selected surface. For example, in step 2224, processor 210 may cause light source 1910 to emit light and may adjust the one or more reflectors 1920 to direct the light to a selected surface (e.g., 1930, 2120, 2130, etc.). Thus, in step 2224, processor 210 may cause projection component 1850 to project the informational image including the one or more items of information onto a selected surface (e.g., 1930, 2120, 2130, etc.) so that user 100 may be able to view the information regarding a recognized individual 2110 or an object in environment 2100 of user 100.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A wearable apparatus, comprising:
an image sensor configured to capture a plurality of images from an environment of a user;
a light projector; and
at least one processor programmed to:
receive at least one image of the plurality of images;
identify an item of information based on the at least one image;
select a surface located within a field of view of the user;
render the item of information into an informational image; and
cause the projector to project the informational image onto the surface.

2. The wearable apparatus of claim 1, wherein the light projector includes:
a light source configured to emit light; and
a reflector configured to direct the emitted light on to the surface.

3. The wearable apparatus of claim 2, wherein the light source is a laser emitter.

4. The wearable apparatus of claim 3, wherein the reflector includes at least one MEMS mirror.

5. The wearable apparatus of claim 2, wherein the processor is programmed to control operations of the light source and the reflector.

6. The wearable apparatus of claim 1, wherein the surface includes a wall located in front of the user.

7. The wearable apparatus of claim 1, wherein the surface includes a wrist of the user.

8. The wearable apparatus of claim 1, wherein the item of information includes at least one of a name of a person within the field of view of the user, a phone number associated with the person, a location, a time, or a date.

9. The wearable apparatus of claim 1, wherein the item of information is associated with a product located in the field of view of the user.

10. The wearable apparatus of claim 1, wherein the processor is further programmed to:
receive an input from the user indicating an approval or a disapproval for projecting the informational image; and
subject to the input indicating an approval, cause the projector to project the informational image onto the surface.

11. The wearable apparatus of claim 1, further including:
at least one microphone configured to capture sounds from the environment of the user,
wherein the processor is further programmed to:
receive at least one audio signal representative of the sounds captured by the at least one microphone; and
identify the item of information based on the at least one image and the at least one audio signal.

12. The wearable apparatus of claim 1, wherein the processor is further programmed to:
transmit the at least one image to a mobile device associated with a user; and
receive the item of information from the mobile device.

13. The wearable apparatus of claim 1, wherein the processor is further programmed to:
identify a plurality of surfaces within the field of view of the user for projecting the informational image; and
select the surface from the plurality of surfaces.

14. The wearable apparatus of claim 1 wherein the processor is further programmed to select the surface based on an analysis of the at least one image, an analysis of a looking direction of the user, a user preference, amount of information to be displayed, a size of the surface, a distance to the surface, a surface orientation relative to the projector, a surface smoothness, or a surface uniformity.

15. The wearable apparatus of claim 1, wherein the processor is further programmed to:
identify at least one human or animal eye in the at least one image;
determine whether the at least one eye is located between the projector and the surface; and
cause the projector to project the informational image when the eye is not located between the projector and the surface.

16. The wearable apparatus of claim 1, wherein the processor is programmed to identify the item of information by:
detecting a face in the at least one image;
comparing the face to a plurality of faces stored in a database; and
determining the item of information based on the comparison.

17. The wearable apparatus of claim 1, wherein the processor is programmed to identify the item of information by:
identifying a street sign in the at least one image;
searching for a street name associated with the street sign in a plurality of maps stored in a database;
selecting a map associated with the street sign based on the searching; and
setting the map as the item of information.

18. The wearable apparatus of claim 1, wherein the processor is programmed to identify the item of information by:
identifying a product in the at least one image;
searching for stores selling the product;
determining prices for the product in the stores selling the product; and
setting the determined prices as the item of information.

19. A method of displaying information to a user, the method comprising:
receiving at least one image captured by an image sensor from an environment of the user;
receiving at least one audio signal representative of sounds captured by at least one microphone from the environment of the user;
identifying an item of information based on at least one of the received at least one image or the received at least one audio signal;
selecting a surface within a field of view of the user;
rendering an informational image comprising the item of information; and
projecting, using a projector, the informational image onto the surface.

20. A non-transitory computer-readable medium storing instructions executable by at least one processor to perform a method, the method comprising:
receiving at least one image captured by an image sensor from an environment of a user;
receiving at least one audio signal representative of sounds captured by at least one microphone from the environment of the user;
identifying an item of information based on at least one of the received at least one image or the received at least one audio signal;
selecting a surface within a field of view of the user;
rendering an informational image comprising the item of information; and
projecting, using a projector, the informational image onto the surface.
